(19) United States
(12) Patent Application Publication
(10) Pub. No.: US 2014/0379361 A1
(43) Pub. Date: Dec. 25, 2014

(54) Healthcare Prepaid Payment Platform Apparatuses, Methods And Systems

(71) Applicants: Shilpak Mahadkar, Foster City, CA (US); Aleema Seadath, Mumbai (IN); Madhu Rangarajan, Mumbai (IN); Uttam Nayak, Mumbai (IN)

(72) Inventors: Shilpak Mahadkar, Foster City, CA (US); Aleema Seadath, Mumbai (IN); Madhu Rangarajan, Mumbai (IN); Uttam Nayak, Mumbai (IN)

(21) Appl. No.: 13/979,516

(22) PCT Filed: Jan. 13, 2012
(86) PCT No.: PCT/US12/21333

§ 371 Date: Mar. 26, 2014

Related U.S. Application Data
(60) Provisional application No. 61/446,728, filed on Feb. 25, 2011.

(30) Foreign Application Priority Data
Jan. 14, 2011 (IN) 132/CHE/2011

(51) Int. Cl. G06F 19/00; G06Q 20/40

(52) U.S. Cl. CPC G06F 19/328; G06Q 20/40
USPC 705/2

(57) ABSTRACT

The healthcare prepaid payment platform apparatuses, methods and systems (hereinafter “HPP-Platform”) transforms patient insurance information, and healthcare procedure schedule information inputs via HPP-Platform components into medical claim settlement outputs. In one embodiment, a healthcare insurance pre-authorization request including healthcare procedure schedule information and user insurance information; receiving an indication of insurance approval of an insured amount from an insurance provider; loading an insurance approved amount into a prepaid account of the user prior to the healthcare procedure; receiving a payment request using the loaded prepaid account towards a medical bill after the healthcare procedure is performed; transferring the loaded insurance approved amount in the prepaid account to a healthcare provider in response to the payment request; and generating a transaction record including the pre-approved amount and the transferred amount.

### RELATED APPLICATION

Applicant hereby claims priority under the Paris Convention, the Patent Cooperation Treaty, and 35 U.S.C. §119 to Indian Provisional Application serial no. 132/CHE/2011, filed Jan. 14, 2011, and U.S. Provisional Application Ser. No. 61/446,728, filed Feb. 25, 2011, both entitled “Apparatuses, Methods And Systems For A Healthcare Prepaid Payment Platform,” both of which are hereby expressly incorporated by reference.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to electronic payment, and more particularly, to HEALTHCARE PREPAID PAYMENT PLATFORM APPARATUSES, METHODS AND SYSTEMS.

### BACKGROUND

Payments to medical establishments may be provided by a patient's health insurance provider. For example, after receiving medical treatment at a healthcare provider (e.g., hospitals, clinics, etc.), the patient may provide his insurance information to the healthcare provider, and the healthcare provider may then communicate with the insurance provider for payment. Once the claim has been settled between the insurance provider and the healthcare provider, the healthcare provider may receive payment (e.g., a check, etc.) from the insurance provider.

### BRIEF DESCRIPTION OF THE DRAWINGS

The accompanying appendices and/or drawings illustrate various non-limiting, example, innovative aspects in accordance with the present descriptions:

FIG. 1A-1B show a block diagram illustrating data flows between HPP-Platform and affiliated entities within various embodiments of the HPP-Platform;

FIGS. 2A-2C provide logic flow diagrams illustrating HPP-Platform pre-authorization payment within embodiments of the HPP-Platform;

FIGS. 3A-3D provide logic flow diagrams illustrating user-insurance pre-authorization and real-time payment verification within embodiments of the HPP-Platform;

FIGS. 4A-4B provide logic flow diagrams illustrating HPP-Platform user enrollment within embodiments of the HPP-Platform;

FIGS. 5A-5C provide logic flow diagrams illustrating HPP post-payment adjudication and reconciliation within embodiments of the HPP-Platform;

FIGS. 6A-6D provide combined data and logic flow diagrams illustrating user co-pay within embodiments of the HPP-Platform;

FIG. 7 provides an exemplary web application user interface illustrating HPP-Platform pre-authorization request form within embodiments of the HPP-Platform;

FIGS. 8A-9B provide exemplary user interfaces illustrating HPP-Platform mobile wallet UI(s) within embodiments of the HPP-Platform;

FIG. 10 shows a block diagram illustrating embodiments of a HPP-Platform controller;

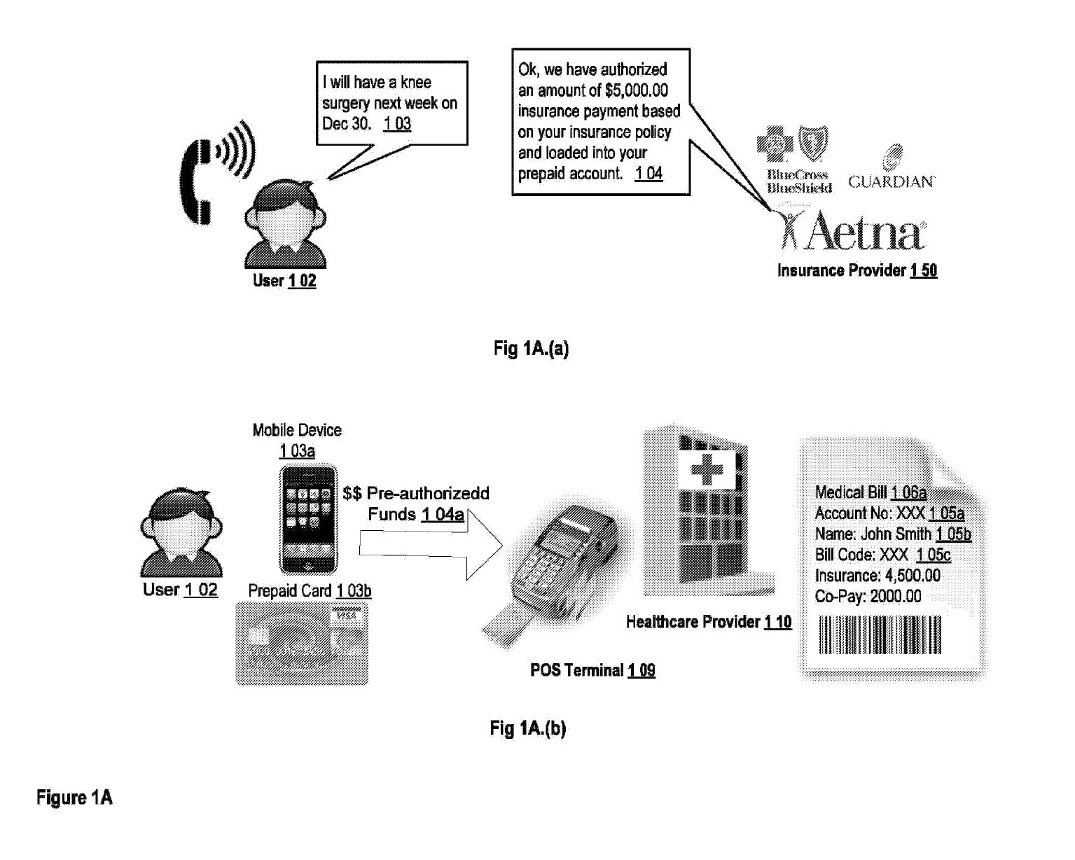

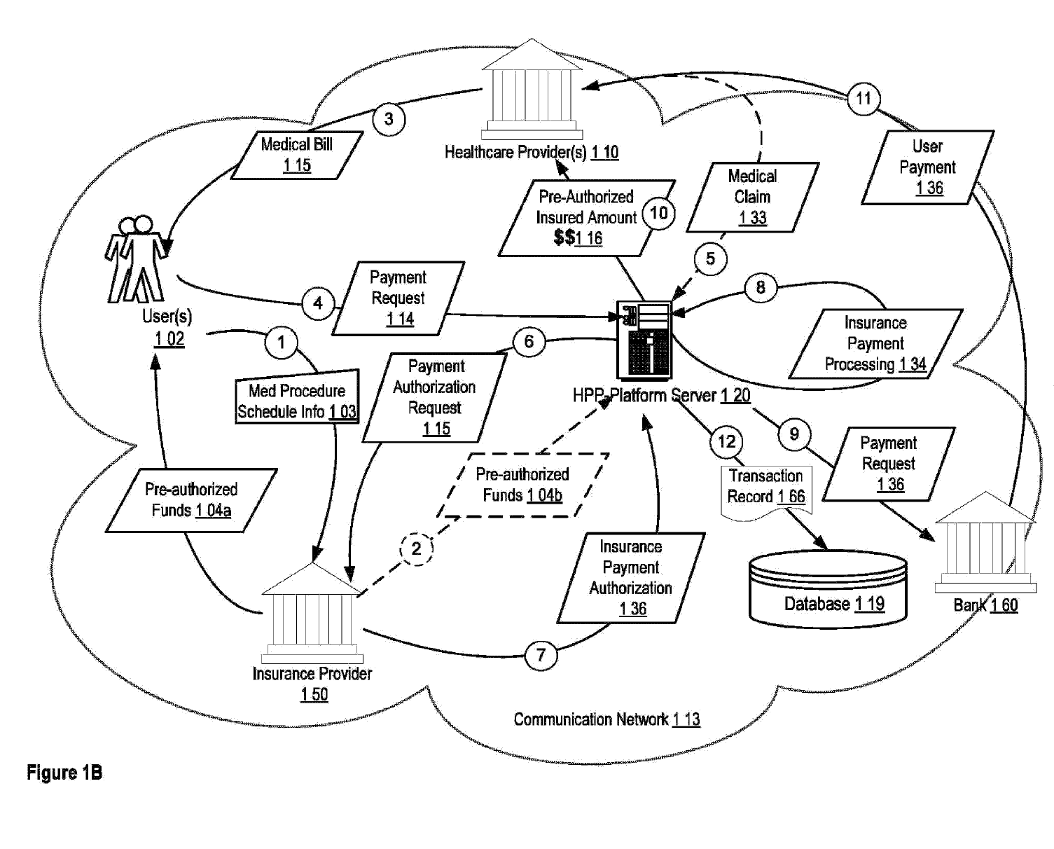

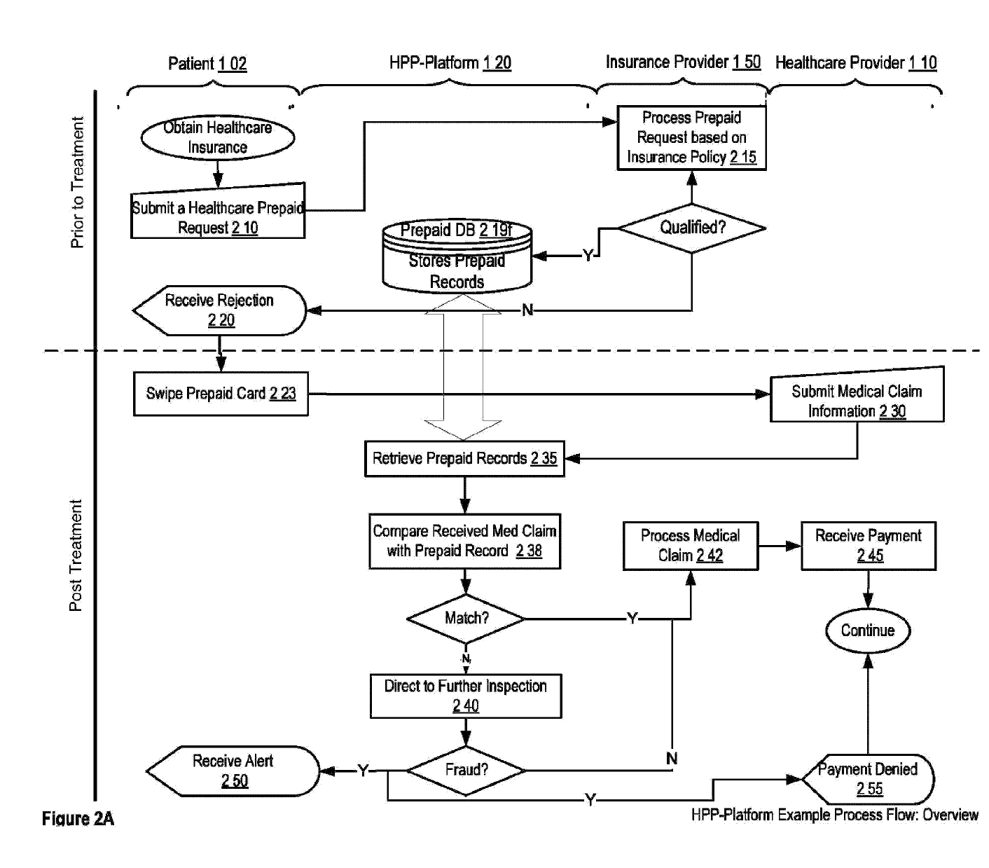

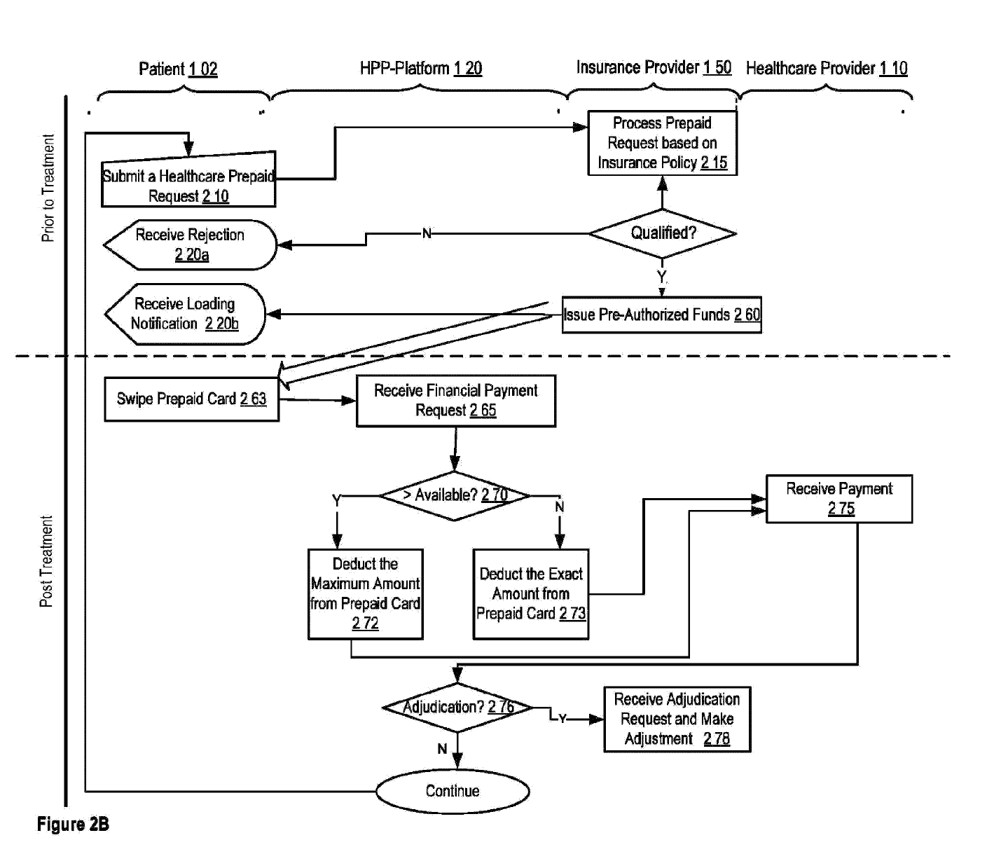

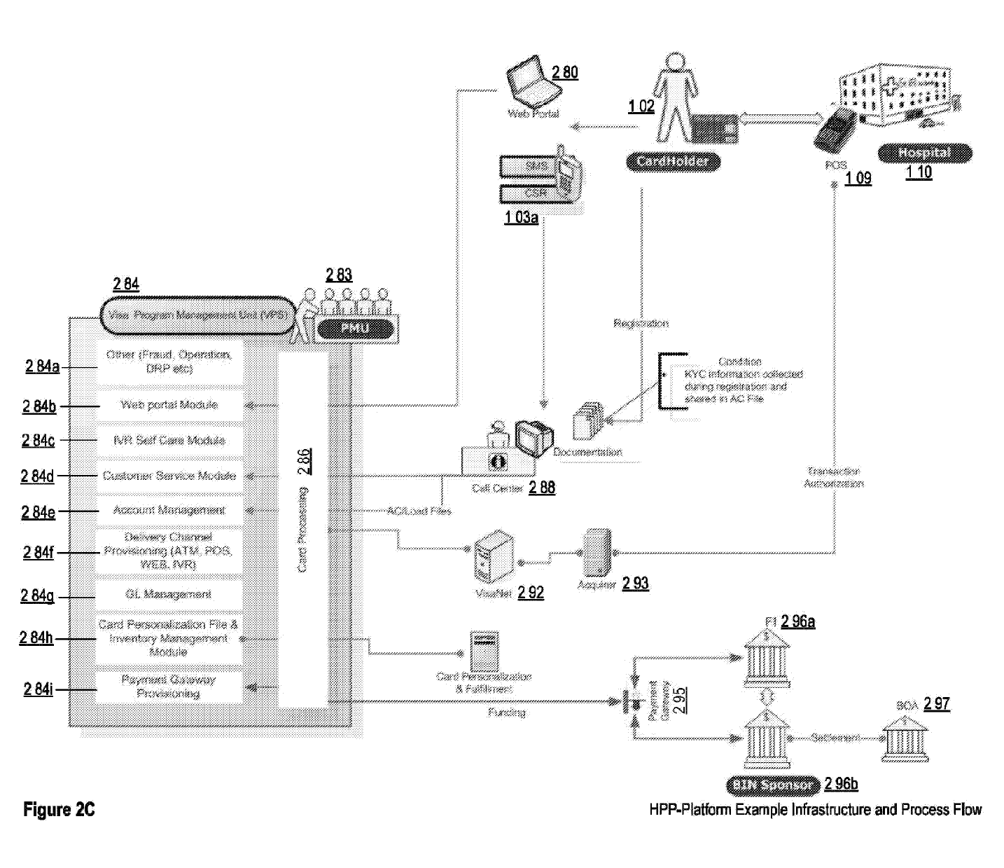

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

HEALTHCARE PREPAID PAYMENT PLATFORM APPARATUSES, METHODS AND SYSTEMS (hereinafter “HPP-Platform”) provides a healthcare prepaid payment platform, whereby medical payments may be executed by insured patients after loading their prepaid cards at a healthcare provider. Within implementations, HPP-Platform may issue a prepaid card to a user and may load the card at time of claim approval through an automated process by a third party financial processing entity (e.g., EMeditek) member. The amount once approved automatically may be loaded onto the prepaid card. A notification sent to the cardholder or policyholder will alert them to make the payment to the hospital.

In one embodiment, a patient may possess a HPP-Platform prepaid card, which may comprises the patient's profile information associated with the HPP-Platform service, such as, but not limited to patient's name, address, medical conditions, medical treatment, insurance policy, and/or the like. In one implementation, the patient may submit a verification request to the insurance provider indicating a scheduled medical treatment prior to the medical appointment. Within implementations, the patient may indicate the type of the medical treatment, identification of the healthcare provider, and/or the like, based on which the insurance provider may pre-approve a payment amount associated with the potential medical treatment for the patient. In one implementation, upon receiving medical treatment, the patient may swipe the HPP-Platform prepaid card at the registry (e.g., a point-of-sale terminal, etc.) at the healthcare provider, and the insurance provider may authorize an insured amount of payment to the healthcare provider. Within implementations, the HPP-Platform facilitated pre-loaded insured amount in a user's prepaid card, may expedite healthcare claim processing, reduce processing latency in healthcare claim adjudication and reconciliation. For example, a user may trigger payment of an approved insured amount to the healthcare provider by swiping his prepaid card pre-loaded by the insurance provider without the healthcare provider submitting a medical claim and wait for the insurance provider to process.

For example, the average time for treatment plan to be inputted into the web application is 30 minutes. The claim approval time may not exceed 2 hours, and the cardholder may receive instant load notification via text messages, emails, and/or the like. In another implementation, the instant load may be based on approval of claim amount, and an average for total transaction from time of discharge for payment processing may be 2.5 hours. In one implementation, the healthcare provider may receive the same day payment, which may be provided as per normal settlement with a merchant.

In one embodiment, the HPP-Platform may facilitate electronic payment from the insurance provider to the healthcare provider. In an alternative embodiment, the HPP-Platform may generate a paper check for payment if electronic payment transfer is not available, or upon request of the healthcare provider.

In one implementation, the HPP-Platform may perform authorization, clearing and settlement of the medical claims upon receiving insured patient card information from a healthcare provider. The HPP-Platform cards may be issued via a commercial bank, wherein the issuing commercial bank may connect the patient's bank account with the HPP-Platform prepaid card.

In a further implementation, the HPP-Platform may allow the patient to pay the uninsured amount of the medical payment to the healthcare provider via the HPP-Platform prepaid card. For example, the patient may register a bank account associated with the HPP-Platform prepaid card, and authorize the healthcare provider to charge the uninsured amount by swiping his card at the healthcare provider. In one implementation, the HPP-Platform may communicate with the patient's bank and facilitate fund transfer from the patient's bank account to the healthcare provider.

In a further implementation, the HPP-Platform may adopt a variety of user payment vehicles, such as, but not limited to a card, a cellular phone, a smart phone, a PDA, an electronic security key, and/or the like. For example, a patient may associate his personal cellular phone with the HPP-Platform, and after receiving a medical treatment, he may send a prepaid request to the HPP-Platform by a text message, a phone call, or an email to customer service. The HPP-Platform may the verify the medical conditions and authorize the transaction.

### HPP-Platform

FIG. 1A provides an exemplary user-HPP-Platform interaction within embodiments of the HPP-Platform. In one embodiment, as shown in FIG. 1A(a), a user 102, e.g., a patient, etc., may schedule a medical procedure with a healthcare service provider, and provide the scheduled medical appointment information to his insurance carrier 150 for pre-authorization. For example, in one implementation, the user 102 may make a phone call to an insurance provider providing medical procedure details, e.g., the user “will have a knee surgery next week” 103, etc. The insurance carrier may receive the medical procedure information and verify whether the provided medical service qualifies for an insured amount. If so, the insurance carrier may provisionally load a pre-authorized insurance amount to the user's prepaid HPP-Platform card, e.g., “$5000.00” pre-authorized “insurance payment” 104.

In one implementation, as shown in FIG. 1A.(b), upon the user receiving medical service at a healthcare provider, the healthcare provider 110 may issue a medical bill 106a, which may comprise information such as a user account number 105, user name 105b, bill code 105c, proposed insurance amount and user's co-pay amount. In one implementation, the user 102 may receive a print out of the bill at healthcare provider 110, and/or receive an electronic bill at his mobile device 103a (e.g., via email, text message, etc.). The user 102 may operate the re-loaded HPP-Platform vehicle, e.g., an electronic wallet enabled mobile device 103a, a prepaid magnetic card 103b, etc., for payment at a healthcare provider 110 upon receiving medical service, e.g., after the scheduled knee surgery. In one implementation, a user 102 may provide a HPP-Platform vehicle a point of sale (POS) terminal 109 at the healthcare provider 110 for payment. For example, the user 102 may swipe a magnetic prepaid card 103b, or just tap on his mobile wallet 103a (e.g., an Apple iPhone, etc.) to initiate payment at the POS terminal 109. Upon verification from the insurance provider 150, the provisionally pre-authorized funds 104a loaded into the user's prepaid card may be transferred to the healthcare provider 110 for medical claim. For example, the pre-authorized funds 104a may be provisionally loaded into the user's prepaid vehicle for insurance payment, and may be confirmed upon the insurance carrier's verification, e.g., verifying whether the tentatively paid medical service matches with the user previously scheduled medical service at 103, etc.

FIG. 1B provides a data block diagram illustrating data flow between entities within embodiments of the HPP-Platform. FIG. 1B shows a block diagram illustrating data flows between HPP-Platform server and affiliated entities within various embodiments of the HPP-Platform. Within various embodiments, one or more user(s) (patient(s)) 102, HPP-Platform server 120, HPP-Platform database(s) 119, healthcare provider(s) 110, insurance provider 150, and/or the like are shown to interact via various communication networks 113.

Within various embodiments, the patient 102 may include a wide variety of different communications devices and technologies within embodiments of HPP-Platform operation. For example, in one embodiment, the patient 102 may operate devices such as, but not limited to, terminal computers, work stations, servers, cellular telephony handsets, smart phones, PDAs, and/or the like. In one embodiment, the HPP-Platform server 120 may be equipped at a terminal computer of the patient 102. In another embodiment, the HPP-Platform server 120 may be a remote server which is accessed by the user 102 via a communication network 113, such as, but not limited to local area network (LAN), in-house intranet, the Internet, and/or the like. In a further implementation, the HPP-Platform merchant 116 may be integrated with a user 102 at a computer terminal.

Within implementations, the user 102 may submit medical procedure schedule/appointment information 103 to an insurance provider 150 prior to the scheduled appointment. For example, the user may call an insurance provider representative 150, to inform the user's scheduled medical service information, pricing estimate, insurance profile information, and/or the like.

For example, in one implementation, the insurance provider 150 may keep the user submitted medical procedure appointment information 103 in a record. An exemplary eXtensible Markup Language (XML) formatted user pre-service appointment record 103 may take a form similar to the following:

```
MedSchedule>
    <User>
        <UserName> John Smith </UserName>
        <UserID> JS0000 </UserID>
        <AccountNo> 0000 0000 0000 </AccountNO>
        <Password> 0000 </Password>
        <PasswordQ>
            <Question1> Where were you born </Question1>
            <Answer1> New York </Answer>
            ...
        </PasswordQ>
        ...
    </User>
  <BIN> 0009090fdsfdf </BIN>
    <Insurance>
        <InsuranceID> BB0008PPO </Insurance>
        <InsuranceType> Regular </InsuranceType>
        <InsuranceCoverage>
            <ProcedureCode1> 60% </ProcedureCode1>
            <ProcedureCode2> 60% </ProcedureCode2>
            ...
    </Insurance>
        ...
    <Procedure>
        <Date> 09-09-2011 </Date>
        <Provider> St Paul Hospital </Provider>
        <ProcedureID> Sur0001 </ProcedureID>
        <ProcedureCode> Sur-Knee-Left </ProcedureCode>
        <ProcedureDescription> ... </ProcedureDescription>
        ...
    </Procedure>
    <CostEstimate>
        <Total> 12,345.00 </Total>
        <Anesthetics> 2,000.00 </Anesthetics>
        <Procedure> 7,800.00 </Procedure>
        <UnitCare> ... </UnitCare>
        ...
    </CostEstimate>
...
</MedSchedule>
```

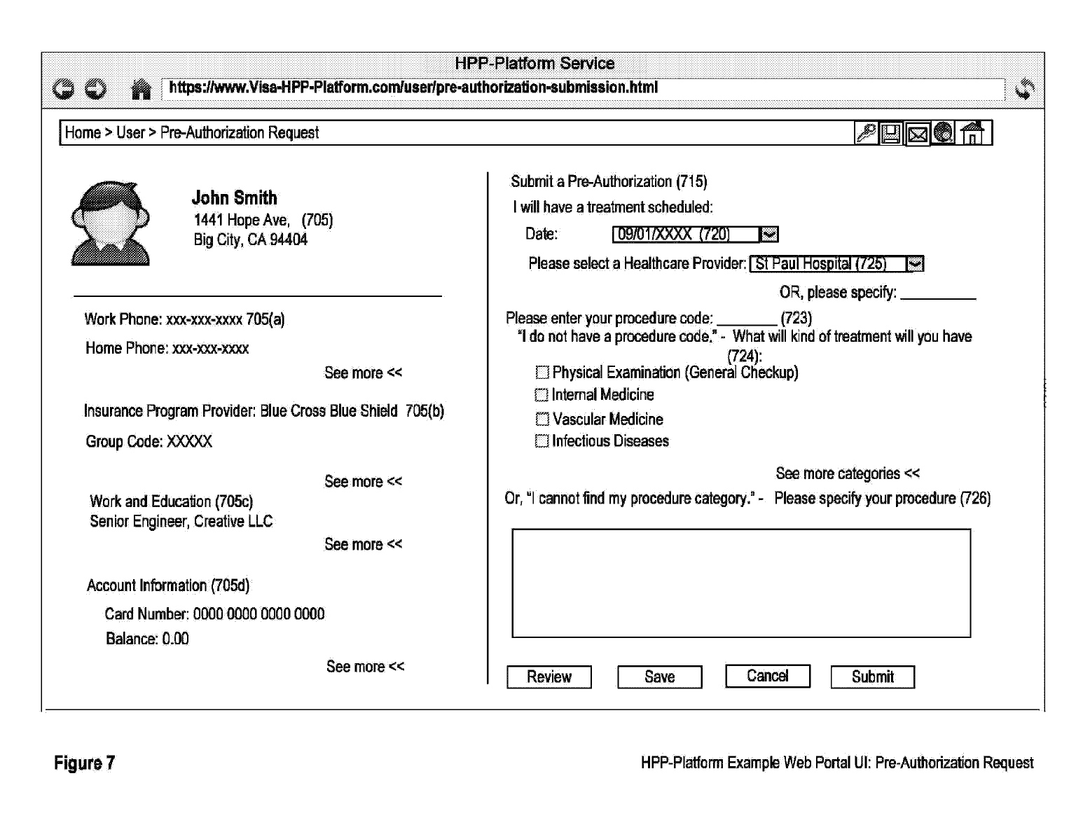

For example, FIG. 7 provides an exemplary web application user interface (UI) for a user to fill in medical appointment information 103 for insurance pre-authorization. As shown in FIG. 7, a user may enter his profile page 705, and view a profile summary including his phone numbers, residential address, insurance information 705b, account information 705d, and/or the like. The user may select to submit a pre-authorization request 715 by entering information such as a date for the scheduled treatment 720, healthcare provider name, procedure code 723, and/or the like. If the user does not have a procedure code, the user may either navigate a list of medicine categories to select a procedure 724, or may enter a description of the procedure 726.

Back to FIG. 1B, in one embodiment, the insurance provider 150, upon receiving the user submitted medical procedure schedule information 103, may assess the medical procedure and determine an insured amount based on the user's insurance policy. In one implementation, the insurance provider 150 may transfer pre-authorized funds 104a to the user's HPP-Platform account, e.g., making a deposit. Within implementations, the pre-authorized funds 104a may be provisionally deposited to the user's HPP-Platform account which may be confirmed upon user's confirmation of receiving medical service. Alternatively, the pre-authorized funds 104a may be loaded into user's HPP-Platform account, which may in turn serve as a debit card having the loaded funds.

In an alternative implementation, upon pre-authorization of insurance payment, the insurance provider 150 may send a message of pre-authorized funds 104a to a payment processing platform (e.g., VisaNet, etc.) including a HTTPS POST message including information of pre-authorization 104a in the form of data formatted according to the XML. Below is an example HTTP(S) POST message including an XML-formatted message for the HPP-Platform server:

```
POST /pre-authorization.php HTTP/1.1
Host: www.HPP.com
Content-Type: Application/XML
Content-Length: 718
<?XML version = “1.0” encoding = “UTF-8”?>
<PreAuthorization>
            <User>
            <UserName> John Smith </UserName>
            <UserID> JS0000 </UserID>
            <AccountNo> 0000 0000 0000 </AccountNo>
            <Password> 0000 </Password>
            <PasswordQ>
                <Question1> Where were you born </Question1>
                <Answer1> New York </Answer>
                ...
            </PasswordQ>
            ...
      </User>
      <Insurance>
            <InsuranceID> BB0008PPO </Insurance>
            <InsuranceType> Regular </InsuranceType>
            <InsuranceCoverage>
                <ProcedureCode1> 60% </ProcedureCode1>
                <ProcedureCode2> 60% </ProcedureCode2>
                ...
      </Insurance>
    ...
    <Time> 19:20:23 </Time>
    <Date> 09-01-2011 </Date>
    <Funds> 5,000.00 </Funds>
    <Status> Pending </Status>
    <Confirmation> Required </Confirmation>
    <Verification> Required </Verification>
    ...
</PreAuthorization>
```

In the above example, the insurance provider 150 may send a pre-authorization message 104a to the HPP-Platform notifying the pre-authorized fund deposit into the user's account. The pre-authorized funds may have a status of “pending” as showing on the user's account, and may be confirmed to be eligible to use upon user's confirmation (e.g., triggering payment for the scheduled medical procedure, etc.), and verification, e.g., upon insurance carrier's verification.

In an alternative implementation, the insurance provider 150 may send a CSV file to HPP-Platform, including instructions to load pre-authorized funds into the user's prepaid account. For example, the pre-authorization to load a card may take a form similar to the following:

| | Product | Customer | Amount | Amount | Exchange | Loading | Transaction |
|---|---|---|---|---|---|---|---|
| Current Format | Code | Id | Received | Received | Rate | Amount | Id |
| Field Size | 6 | 20 | 3 | 25 | 6 | 25 | 20 |
| Type | AN | AN | A | Number and | Number and | Number and | N |
| | | | | Decimal | Decimal | Decimal | |
| Mandatory/Optional | Mandatory | Mandatory | Mandatory | Mandatory | Mandatory | Mandatory | Mandatory |
| RELOAD_201201090001 | PRO001 | 99870366202 | INR | 2000.00 | 1.0000 | 2000.00 | 9987036620 |

In one embodiment, at the date of the scheduled medical treatment, upon receiving healthcare treatment at the healthcare provider 110, the user 102 may receive a medical bill 115, indicating the details of the treatment, and the payment amount due, including an amount of the insurance coverage, and the patient's co-pay amount. For example, the user may receive a printed bill at the POS terminal at the hospital (e.g., 109 in FIG. 1A); may receive an electronic bill in the email, instant messaging, a healthcare web portal, a mobile wallet (e.g., 103a in FIG. 1A), and/or the like. The healthcare provider 110 may pre-check the insurance information of the patient, and thus make an estimate of the insured amount and user co-payment amount, which may be reflected into the medical bill 115. For example, in one implementation, an exemplary XML implementation of the medical bill 115 may take a form similar to:

```
<MedBill>
      <BillID> MD 0000123 </BillID>
      <BillDate> 09-09-2000 </BillDate>
      <BillTimeStamp> 14:23:56 </BillTimeStamp>
      <BillCode> 0543 </BillCode>
      <Patient>
      <UserID> 123456789 </UserID>
      <UserName> John Smith </UserName>
      </UserAddress> 111 White road </UserAddress>
      <UserPhoneNumber> 000-000-2222 </UserPhoneNumber>
      ...
      </UserDeviceID> 11111111 </UserDeviceID>
      <UserLicenseInfo> .....</UserLicenseInfo>
      ...
      </Patient>
      ...
      <Procedure>
      <ProcedureCode> Sur-Knee-Left </ProcedureCode>
      <ProcedureDate> 09-09-2011 </ProcedureDate>
      <ProviderID> SPH001 </ProviderID>
      <ProviderName> St Paul Hospital </ProviderName>
      ...
      </Procedure>
      <Insurance>
      <InsuranceID> BB0008PPO </Insurance>
      <InsuranceType> Regular </InsuranceType>
      <InsuranceCoverage>
        <ProcedureCode1> 60% </ProcedureCode1>
        <ProcedureCode2> 60% </ProcedureCode2>
        ...
      </Insurance>
<BillSummary>
      <TotalAmount> 12,000.00 </TotalAmount>
      <Insured> 5,000.00 </Insured>
      <PatientResp> 7,000.00 </PatientResp>
      <AmountDue> 7,000.00 </AmountDue>
      ...
</BillSummary>
...
</MedBill>
```

In one implementation, the healthcare provider may generate a HTTP POST message to the HPP-Platform, seeking for medical claim 133, wherein the XML-formatted message may take a form similar to:

```
POST /ClaimRequst.php HTTP/1.1
Host: www.Hospital.com
Content-Type: Application/XML
Content-Length: 718
<?XML version = “1.0” encoding = “UTF-8”?>
<AuthorizationRequest>
<Header>
            <Bin> 000000 </Bin>
            <CountNo> 000001 </CountsNo>
            <ControlNo> 00002 </ControlNo>
            <PharmacyID> CVS0001 </PharmacyID>
            <Date> 09-09-2011 </Date>
            ...
</Header>
<User>
            <UserName> John Smith </UserName>
            <UserID> JS0000 </UserID>
            <AccountNo> 0000 0000 0000 </AccountNO>
            <Password> 0000 </Password>
            <PasswordQ>
                <Question1> Where were you born </Question1>
                <Answer1> New York </Answer>
                ...
            </PasswordQ>
            ...
    </User>
    <Insurance>
            <InsuranceID> BB0008PPO </Insurance>
            <InsuranceType> Regular </InsuranceType>
            <InsuranceCoverage>
                <ProcedureCode1> 60% </ProcedureCode1>
                <ProcedureCode2> 60% </ProcedureCode2>
                ...
      </Insurance>
    ...
    <Time> 19:20:23 </Time>
  <Date> 09-01-2011 </Date>
<Claim>
            <Procedure>
            <ProcedureCode> Sur-Knee-Left </ProcedureCode>
            <ProcedureDate> 09-09-2011 </ProcedureDate>
            <ProviderID> SPH001 </ProviderID>
            <ProviderName> St Paul Hospital </ProviderName>
            ...
            </Procedure>
            <TotalAmount> 12,000.00 </TotalAmount>
            <EstimatedInsured> 5,000.00 </EstimatedInsured>
            <PatientResp> 7,000.00 </PatientResp>
            ...
</Claim>
...
</ClaimRequest>
```

In an alternative implementation, the healthcare provider may not submit a medical claim 133 to the HPP-Platform by identifying the user as eligible for HPP-Platform pre-authorized insurance loading service. Within implementations, in response to the received medical bill, e.g., at the POS terminal at the healthcare provider 110, the patient 102 may submit a medical payment request 114 to an acquirer 130, which may forward the payment request 114b to the HPP-Platform server 120 for processing. In one implementation, the payment request 114 may comprise information such as user profile information, user insurance information, user pre-loaded account information, medical bill information, and/or the like. For example, in one implementation, a POS terminal processing the user payment request may generate a HTTPS POST message including information of the payment request 114 in the form of data formatted according to the XML. Below is an example HTTP(S) POST message including an XML-formatted message for the HPP-Platform server:

```
POST /PaymentRequst.php HTTP/1.1
Host: www.Hospital.com
Content-Type: Application/XML
Content-Length: 718
<?XML version = “1.0” encoding = “UTF-8”?>
<PaymentRequest>
      <Time> 15:30:30 </Time>
      <Date> 09-09-2011 </Date>
      <SourceID> POS00001 </SourceID>
      <User>
      <UserName> John Smith </UserName>
      <UserID> JS0000 </UserID>
      <AccountNo> 0000 0000 0000 </AccountNo>
      <Password> 0000 </Password>
      <PasswordQ>
            <Question1> Where were you born </Question1>
            <Answer1> New York </Answer>
            ...
      </PasswordQ>
      ...
      </User>
        <Insurance>
      <InsuranceID> BB0008PPO </Insurance>
      <InsuranceType> Regular </InsuranceType>
      <InsuranceCoverage>
            <ProcedureCode1> 60% </ProcedureCode1>
            <ProcedureCode2> 60% </ProcedureCode2>
            ...
        </Insurance>
      ...
      <Procedure>
      <ProcedureCode> Sur-Knee-Left </ProcedureCode>
      <ProcedureDate> 09-09-2011 </ProcedureDate>
      <ProviderID> SPH001 </ProviderID>
      <ProviderName> St Paul Hospital </ProviderName>
      ...
      </Procedure>
      <PreLoad>
            <Amount> 5000.00 </Amount>
              <Status> Pending </Status>
            <Confirmation> Required </Confirmation>
            <Verification> Required </Verification>
      ...
      </PreLoad>
</PaymentRequest>
```

In the above example, as the payment request 114 indicates the pre-loaded funds in the user HPP-Platform account is “pending” and requests “verification” for usage, the HPP-Platform may generate a payment authorization request 115 message to the insurance provider, wherein the insurance provider may verify whether the medical treatment at issue matches with the pre-authorized medical treatment. For example, the HPP-Platform may generate a HTTPS POST message to make an authorization request 115 in the form of data formatted according to the XML. Below is an example HTTP(S) POST message including an XML-formatted message of the authorization request 115 for the HPP-Platform server:

```
POST /AuthorizationRequst.php HTTP/1.1
Host: www.HPP-Platform.com
Content-Type: Application/XML
Content-Length: 718
<?XML version = “1.0” encoding = “UTF-8”?>
<AuthorizationRequest>
<Time> 17:40:40 </Time>
<Date> 09-09-2011 </Date>
<User>
            <UserName> John Smith </UserName>
            <UserID> JS0000 </UserID>
            <AccountNo> 0000 0000 0000 </AccountNo>
            <Password> 0000 </Password>
            <PasswordQ>
                <Question1> Where were you born </Question1>
                <Answer1> New York </Answer>
                ...
            </PasswordQ>
            ...
</User>
<Insurance>
            <InsuranceID> BB0008PPO </Insurance>
            <InsuranceType> Regular </InsuranceType>
            <InsuranceCoverage>
                <ProcedureCode1> 60% </ProcedureCode1>
                <ProcedureCode2> 60% </ProcedureCode2>
                ...
  </Insurance>
            ...
<Procedure>
            <ProcedureCode> Sur-Knee-Left </ProcedureCode>
            <ProcedureDate> 09-09-2011 </ProcedureDate>
            <ProviderID> SPH001 </ProviderID>
            <ProviderName> St Paul Hospital </ProviderName>
            ...
</Procedure>
<Claim>
            <Amount> 5,000.00 </Amount>
            <Status> Pre-loaded </Status>
            ...
</Claim>
...
</AuthorizationRequest>
```

The insurance provider 150 may review and verify the requested insurance payment. In one implementation, the insurance provider 150 may verify the pre-loaded payment on-the-fly, e.g., sending an insurance payment authorization back to the HPP-Platform to authorize the payment before the transaction is finalized. In another implementation, the HPP-Platform may process the user's payment request 114 without insurance provider's further confirmation, but may obtain adjudication and authorization afterwards.

Upon reviewing and approving the requested insured amount, the insurance provider 150 may provide a response to the payment authorization request 115, either to approve the requested insurance payment, or reject the payment request when the received information does not match the pre-authorized information at 103. For example, the insurance provider 150 may verify whether the estimated insured amount in the payment request 115 matches the pre-authorized insured amount in 104a calculated by the insurance program coverage percentage, whether underlying procedure performed in 115 matches that in the received procedure schedule information 103, and/or the like. In a further implementation, the insurance provider may apply pre-stored rules to determine whether the payment request is “consistent,” which may allow a level of tolerance of difference, e.g., when the scheduled procedure in indicates a “knee surgery on the left,” but the procedure performed as indicated in includes a “knee surgery on the left plus cosmetic skin reconstruction,” such difference may be considered as tolerable.

In one implementation, the insurance provider may generate a HTTPS POST message to make an authorization response 136 in the form of data formatted according to the XML. Below is an example HTTP(S) POST message including an XML-formatted message of the authorization response 136 for the HPP-Platform:

```
POST /AuthorizationResponse.php HTTP/1.1
Host: www.HPP-Platform.com
Content-Type: Application/XML
Content-Length: 718
<?XML version = “1.0” encoding = “UTF-8”?>
<AuthorizationResponse>
<Time> 17:42:40 </Time>
<Date> 09-09-2011 </Date>
<User>
        <UserName> John Smith </UserName>
        <UserID> JS0000 </UserID>
        <AccountNo> 0000 0000 0000 </AccountNo>
        <Password> 0000 </Password>
        <PasswordQ>
        <Question1> Where were you born </Question1>
        <Answer1> New York </Answer>
        ...
    </PasswordQ>
    ...
</User>
<Insurance>
    <InsuranceID> BB0008PPO </Insurance>
    <InsuranceType> Regular </InsuranceType>
    <InsuranceCoverage>
        <ProcedureCode1> 60% </ProcedureCode1>
        <ProcedureCode2> 60% </ProcedureCode2>
        ...
</Insurance>
    ...
<Procedure>
    <ProcedureCode> Sur-Knee-Left </ProcedureCode>
    <ProcedureDate> 09-09-2011 </ProcedureDate>
    <ProviderID> SPH001 </ProviderID>
    <ProviderName> St Paul Hospital </ProviderName>
    ...
</Procedure>
<ApprovedAmount> 5,000.00 </ApprovedAmount>
<Status> Match </Status>
...
</AuthorizationResponse >
```

Upon receiving the insurance payment authorization 136, the HPP-Platform may process the insurance payment 134, and confirm the payment 116 made from the user's pre-loaded account to the healthcare provider.

In one implementation, the HPP-Platform may transfer the pre-loaded insured amount of funds 116 to the healthcare provider's bank account. For example, the HPP-Platform may send the payment request 136 to a bank 160 (e.g., the user's bank, etc.), which may take a form similar to the format in compliance with electronic fund transfers (EFT), and in some embodiments, it may be directly made to the healthcare provider via a third party bank, e.g., absent the direction of the HPP-Platform server. In another implementation, the user may elect to pay the user co-payment via the payment request 114, and eventually the user co-pay may be performed along with the insured amount 116. In one implementation, the HPP-Platform server 120 may debit the co-payment amount from the user's account and credit to the healthcare provider 110. For example, the HPP-Platform server may generate a HTTPS post for money transfer. For another example, the fund transfer message may take a form similar to the Visa Single Message System (SMS) format, Visa Original Credit Transaction (OCT) format, and/or the like.

In one implementation, the HPP-Platform server 120 may generate a transaction record 166 in the database 119. For example, the HPP-Platform may generate a HTTPS POST message to make a database record in the form of data formatted according to the XML. Below is an example HTTP(S) POST message including an XML-formatted message of the transaction record 166 for the HPP-Platform server:

```
POST /TransactionRecord.php HTTP/1.1
Host: 255.25.222.0
Content-Type: Application/XML
Content-Length: 718
<?XML version = “1.0” encoding = “UTF-8”?>
<Transaction>
    <TransactionID> 000000 </TransactionID>
    <TransactionDate> 09-09-2011 </TransactionDate>
    <PreAuthorizationTime> 09-01-2011 </PreAuthorizationTime>
    <RequestTime> 19:30:27 </RequestTime>
    <ReceiptTime> 19:31:56 </ReceiptTime>
    <User>
    <UserName> John Smith </UserName>
    <UserID> JS0000 </UserID>
    <AccountNo> 0000 0000 0000 </AccountNo>
    <Password> 0000 </Password>
    <PasswordQ>
        <Question1> Where were you born </Question1>
        <Answer1> New York </Answer>
        ...
    </PasswordQ>
    ...
    </User>
    <TotalAmount> 12,000.00 </TotalAmount>
    <Insured> 5,000.00 </Insured>
    <PatientResp> 7,000.00 </PatientResp>
    <TransferLog>
        <Transfer1>
            <Amount> 5,000.00 </Amount>
            <FundSource> Insurance </FundSource>
            <FundType> Pre-Load </FundType>
            <TransactionTime> 19:31:27 </TransactionTime>
            <Payee> St Paul Hospital </Payee>
            <Status> Verified </Status>
            ...
        </Transfer1>
        ...
    </Transfer>
...
</Transaction>
```

FIG. 2A shows a block diagram illustrating various embodiments of the HPP-Platform. In one embodiment, when a patient 102 has a scheduled medical appointment, the patient may contact the insurance provider and submit a request for prepaid payment service 110. In one implementation, the patient may call, email, or send a text message of a prepaid request to the customer service of his insurance provider. In an alternative implementation, the HPP-Platform 120 may process the prepaid request and communicate with the insurance provider 150, e.g., 210. Upon receiving the request, the insurance may process the prepaid request based on the insurance policy 215. In one implementation, the insurance provider may determine whether the patient and/or the scheduled medical appointment is qualified for the prepaid payment service. For example, if the patient's scheduled medical treatment is not covered by his insurance policy, the insurance provider may deny prepaid service and the patient may receive a notification of rejection 220.

In another implementation, if the patient and the scheduled medical treatment are verified by the insurance provider, the HPP-Platform may establish an authorized prepaid record and store it in a prepaid database 219f. For example, an example XML code of a prepaid record may take a form similar to the following:

```
<RecordID>
    <PatientName>
        John Smith
    </PatientName>
    <RequestSubmissionTime>
        19:45 09-09-2013
    </RequestSubmissionTime >
    <InsuranceProvider>
    Dental ASD Provider
    </InsuranceProvider>
    <InsurancePlan>
    Dental All Coverage
    </InsurancePlan>
    <RequestMatter>
        <MatterID>
        Dental00090909
        </MatterID >
        <MatterDate>
        09-15-2013
        </MatterDate >
        <Matter>
        root canal therapy
        </Matter>
        <MatterCoverage>
        80%
        </Matter>
        <Provider>
        ABC Dental
        </Provider>
        ...
    <InsurnedAmountMaximum>
        1500.00 </InsurnedAmountMaximum>
    <AllowedAmount> 1000.00 </AllowedAmount>
    ...
</RecordID>
```

As shown in the above example, the patient submitted a request for prepaid service for a dental procedure “root canal therapy” scheduled at “ABC dental” on Sep. 15, 2010, and the insurance provider authorized an up-to 1000.00 dollar medical claim settlement for the provider “ABC dental.”

In one embodiment, after receiving the medical treatment, the patient may submit prepaid service information at the healthcare provider, e.g., swipe his prepaid card 223 at a POS registry, and the healthcare provider 104 may submit medical claim information 130 to the HPP-Platform associated with the patient account information obtained from his prepaid card. In one implementation, the medical claim information may comprise, but not limited to a claimed amount, the date of treatment, healthcare provider's identification information, medical treatment, and/or the like.

In one embodiment, upon receiving the medical claim request, the HPP-Platform may retrieve the previously stored prepaid record 235, which may be similar to the above example, and compare the received patient account and medical claim information with the prepaid record 238 for verification. In one implementation, the HPP-Platform may verify the medical claim via a plurality of criteria. For example, the HPP-Platform may verify the received amount from the healthcare provider exceeds the pre-allowed amount; whether the procedure performed and/or the healthcare provider is consistent with the procedure and/or healthcare provider indicated in the prepaid record. In a further implementation, the HPP-Platform may verify whether the date of the medical treatment performed is within an allowed time frame. For example, if prior to treatment, the patient indicated the treatment would be performed on Sep. 15, 2010, the HPP-Platform may allow a flexibility of plus/minus a period of time, e.g., if the allowable time flexibility is 5 days, and the procedure is performed within Sep. 10-20, 2010, the HPP-Platform may recognize the medical claim as matching the previously authorized prepaid record.

In one embodiment, if one or more criteria do not match the prepaid record, e.g., the requested claim amount exceeds the allowed amount established in the prepaid record, the procedure performed is different from that indicated in the record, etc., the HPP-Platform may direct the payment request to further inspection 240. In one implementation, the HPP-Platform may communicate with the patient and/or the healthcare provider to clarify the inconsistency to allow reasonable flexibility. For example, a HPP-Platform representative may call, text-message and/or email the patient to inquire about the inconsistency and determine whether the received claim request is fraudulent.

In one implementation, if HPP-Platform determines the received medical claim matches the prepaid record, and/or is not fraudulent, the HPP-Platform may send an authorization notice to the insurance provider to process the medical claim 242 and the healthcare provider may receive payment 245.

In another implementation, if the HPP-Platform determines the received medical claim request is fraudulent, e.g., no such prepaid record exists, etc., the HPP-Platform may send an alert to the patient 250, and deny the payment request 255.

FIG. 2B provides a logic flow showing pre-loaded insurance payment without on-the-fly verification within alternative embodiments of the HPP-Platform. Within embodiments, upon receiving a healthcare prepaid loading request, and verifying the user's insurance policy is eligible for prepaid loading service, the HPP-Platform may calculate a pre-authorized amount of insurance payment based on the received medical service information and issue the pre-authorized funds 260 to the user's HPP-Platform prepaid account via an issuing bank. For example, in one implementation, the insurance provider may generate a fund transfer request including indication of pre-authorized funds (e.g., 104b in FIG. 1B) to a financial processing network of the HPP-Platform (e.g., VisaNet, etc.). In one implementation, the user may receive a notification 220b of the pre-authorized loading via automatic or human conducted phone calls, emails, instant messaging, text messages, wallet notifications, and/or the like, e.g., “$5,000.00 pre-approved insured amount for your knee surgery scheduled at St Paul Hospital on Sep. 9, 2011 has been deposited to your HPP-Platform account.” Alternatively, if the user is not eligible, a service rejection may be received, e.g., at 220a.

Within implementations, the pre-authorized funds (e.g., 104a in FIG. 1B) may be deposited into the user prepaid account, wherein the prepaid account may be engaged as a debit account with deposited funds to pay for medical service as long as the payment terminal (e.g., the POS terminal 109 in FIG. 1A) accepts payment from the prepaid account. In such cases, the user may utilize the pre-loaded prepaid account for payment at any participating POS terminals.

In alternative implementations, the insurance provider may restrict usage of the pre-authorized funds. For example, the insurance provider may include tag the pre-authorized funds with a requirement that payment withdrawing such funds may only be accepted at an authorized terminal code (e.g., the POS terminal associated with the healthcare provider consistent with the user submitted medical procedure appointment information at 210). Thus if the user has submitted an appointment with “St Paul Hospital,” the user may not be able to use the pre-authorized funds issued for a surgery at “St Paul Hospital” to pay for a dental visit at “K St Dental Group.”

In one implementation, on the day of the procedure, the user may swipe his prepaid card 263 (or engage a mobile wallet payment) at the POS terminal of the healthcare provider. In one implementation, the POS terminal may verify whether the payment is acceptable, e.g., whether the insurance provider imposed POS terminal code matches with the POS terminal, etc.

Upon receiving financial payment request 265, the HPP-Platform may determine whether the pre-loaded account has sufficient available funds 270 for the requested payment. In one implementation, if the funds is sufficient, the HPP-Platform may deduct the exact amount from the prepaid card 273, and the healthcare provider may receive the payment 275. In another implementation, if there is insufficient funds available, the HPP-Platform may deduct a maximum available amount form the prepaid card 272.

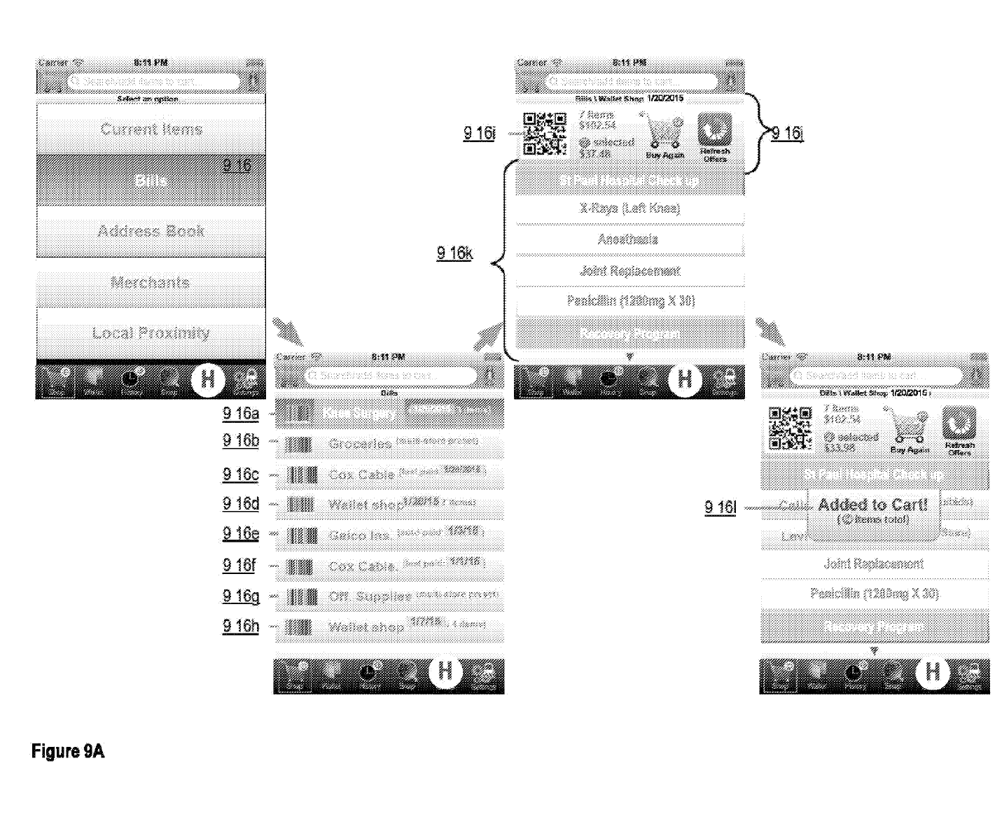

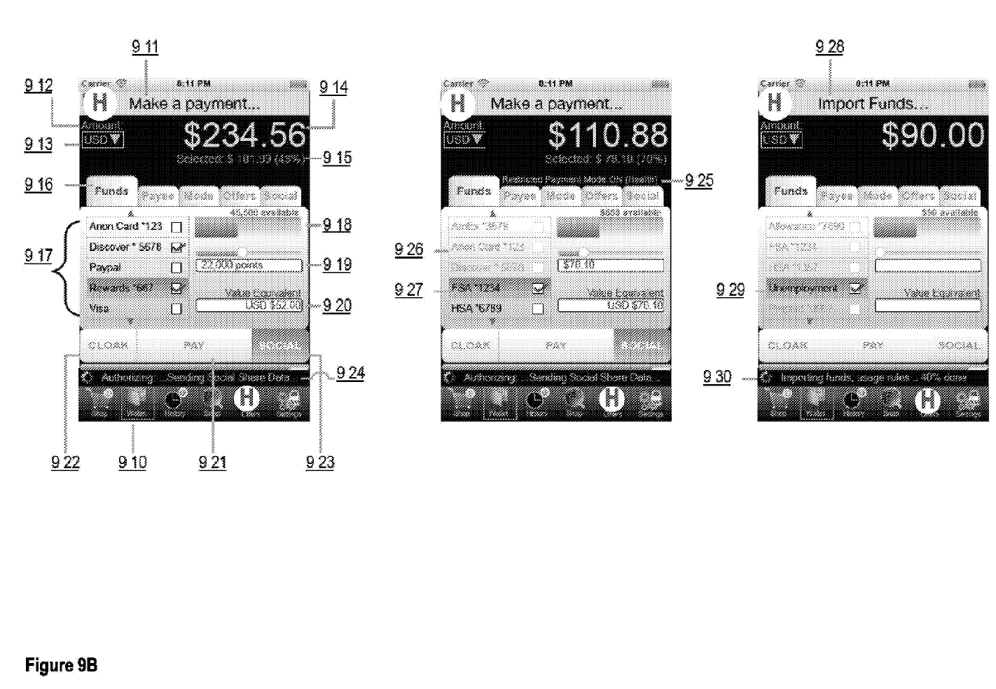

In further implementations, the user may deposit an amount into the HPP-Platform prepaid account for user co-payment. Such user deposit may or may not be combined with the pre-authorized funds issued by the insurance provider. For example, as shown at 115 in FIG. 1B, if the total amount for a knee surgery is $12,000.00 with $5,000.00 insured portion and $7,000.00 user responsibility, and the insurance provider may pre-load the user's HPP-Platform prepaid card with an amount of $5,000.00, the user may pre-load the HPP-Platform prepaid account with an amount of $7,000.00 himself, so that the prepaid account may be loaded with an amount of $12,000.00. In such cases, the user may elect to engage his HPP-Platform prepaid account as a debit account to pay the entire price at the healthcare provider. In alternative implementations, the user may elect to separate the payment of insured amount and user co-payment. For example, the user may elect to link other bank accounts to pay the user responsible portion, and may engage in a variety of payment structures, such as one-time payment, monthly payment, and/or the like. Further implementations of user check-out with HPP-Platform prepaid card are illustrated in FIGS. 9A-9B.

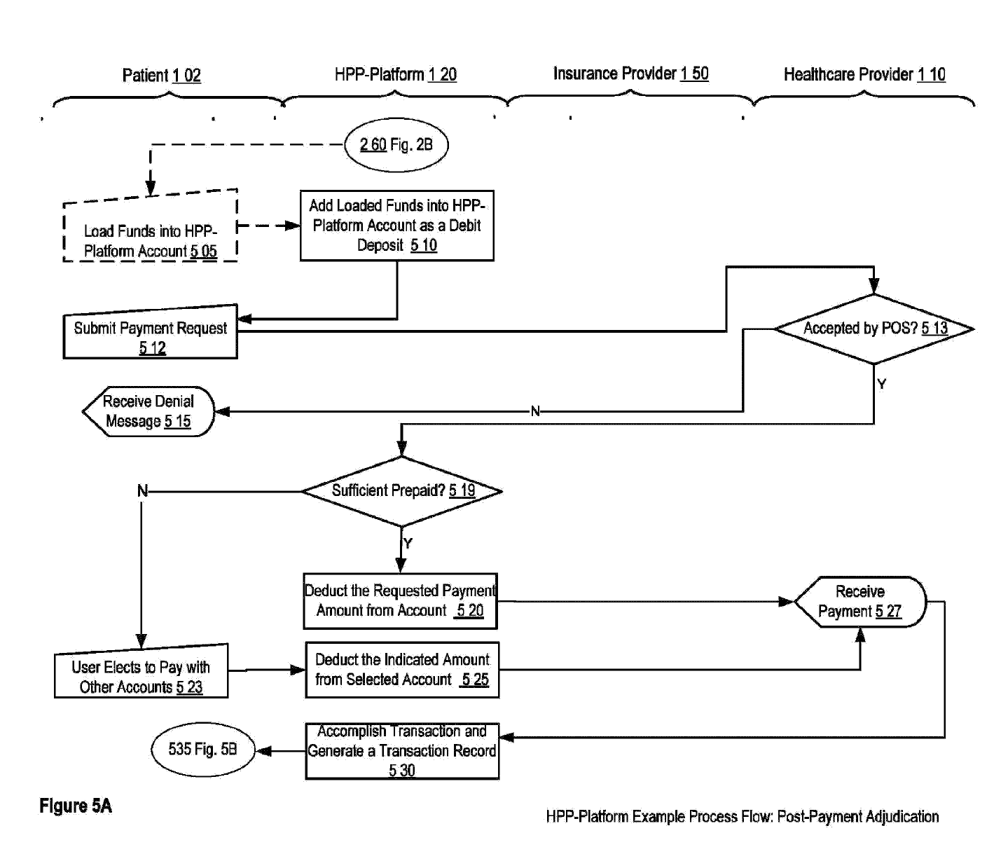

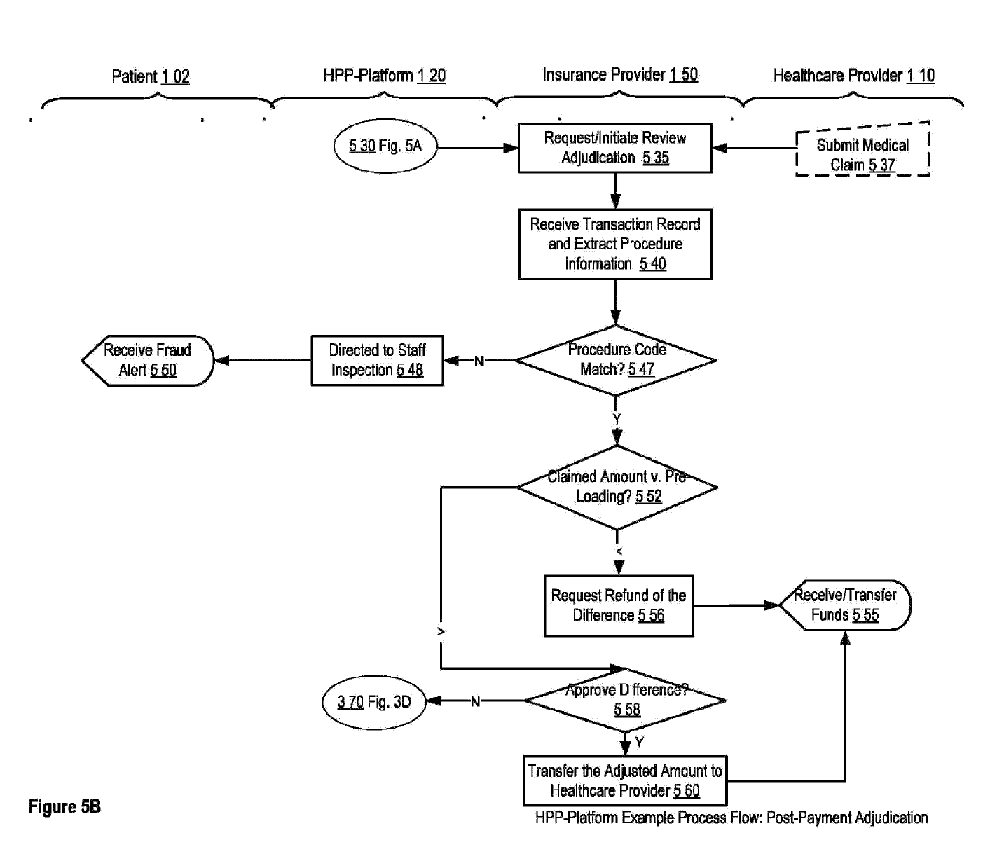

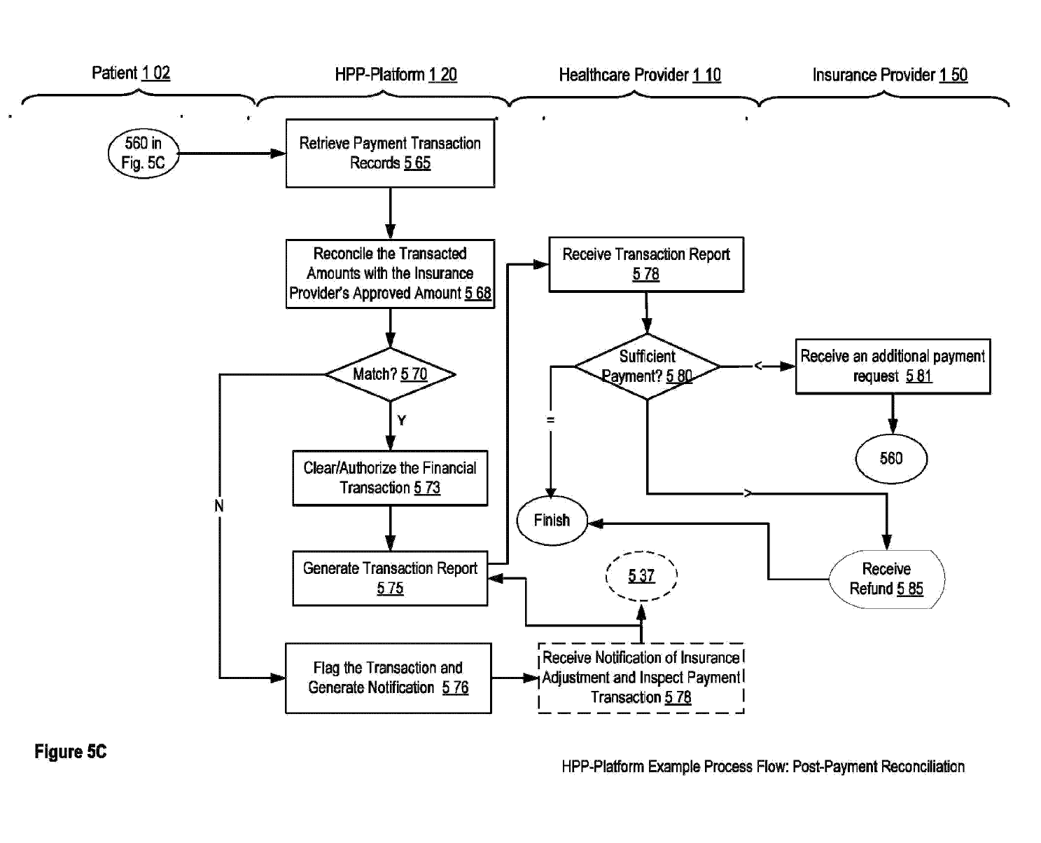

Within implementations, the insurance payment may be subject to post-procedure adjudication and reconciliation 276, wherein the insurance provider may verify whether the engaged pre-loaded funds is consistent with the amount that has been paid and may make payment adjustment based on the reconciliation results 278, as further illustrated in FIGS. 5A-5C.

FIG. 2C provides a block flow diagram illustrating exemplary infrastructure of the HPP-Platform within embodiments of the HPP-Platform. Within embodiments, a prepaid Program Management Unit (PMU) 283, e.g., the Visa Program Management Unit 284, may be operated for planning, implementation, card creation (e.g., to manage the card embossing creation and card inventory management), technology and processing. For example, the PMU may introduce a Visa prepaid card replacing check based payments to healthcare provider post patient care, which may connect the healthcare provider web portal together through a common web based application. The web based application may provide members access to healthcare information and allow members to input treatment plans for approval virtually and obtain real-time approval. In a further implementation, the PMU may provide support through reports to reconcile claim paid to hospitals, as further illustrated in FIGS. 5A-5C.

Within implementations, the PMU may comprise and/or be coupled to a variety components, such as fraud operation 284a, web portal module 284b, self care module 284c, customer service module 284d, account management 284e, delivery channel provisioning 284f, GL management 284g, card personalization file and inventory management module 284h, payment gateway provisioning 284i, and/or the like, which may communicate with the card processing 286 unit for various service requests.

In one embodiment, a cardholder 102 may be issued a prepaid card with Magnetic strip use for POS claim payment (e.g., 120 days post Pilot closure). In further implementations, HPP-Platform may enable card loyalty and GP spending wallets (e.g., as shown in FIGS. 9A-9B), chip card that has photo ID, health related information and other details for information reading by health care provided and POS payment. Card may be multi purse to accommodate other payment schemes.

In one implementation, the user (cardholder) 102 may submit pre-authorization request (e.g., 103 in FIG. 1B) via a web portal 280, mobile messages 103a, a phone call directed to a call center 288, and/or the like. The insurance provider may provide pre-authorized funds into the user's card.

In one implementation, the HPP-Platform may perform funding and load controls, e.g., a float amount for 3-5 days of total average transaction value to be maintained by the payee (e.g., healthcare provider) with the sponsor bank. The control may be placed where the “load” transaction will unauthorized by HPP-Platform if the float amount at the bank falls below the agreed threshold between the bank and the payee, and may check for the outstanding float balance against the amount to be authorized for the load transaction.

Within implementations, the issued cards may facilitates identifying spends at hospitals by Visa merchant. In one implementation, category codes and the terminal level identification number may be used to authorize a particular transaction. terminal ID level acceptance control of load amount on the prepaid card, i.e. acceptance should be limited to specific terminal IDs at a specific medical establishment.

Within implementations, the HPP-Platform may process outstanding load amount for “refunding” outstanding load balance back to the insurance provider if the charged amount is lesser than the loaded amount. This scenario may occur if the post-procedure billing was for some reason lesser than the initial estimated charges authorized by the insurance provider, as further illustrated in FIGS. 5A-5B.

Within implementations, the transaction authorization made via the acquirer 293 and financial processing network (e.g., VisaNet) may be time-bound), e.g., the load amount to be spent at the authorized location and terminal/s within a specific period of time, which may be the authorization time period to accommodate phased billing by the medical establishment (ME), e.g. a $5,000 approved amount, may be billed $2,500 at the time the patient is at the hospital. However there may be subsequent billing with 2 weeks up to the $5,000 limit on the card.

For example, the average time for treatment plan to be inputted into the web application is 30 minutes. The claim approval time may not exceed 2 hours, and the cardholder may receive instant load notification via text messages, emails, and/or the like. In another implementation, the instant load may be based on approval of claim amount, and an average for total transaction from time of discharge for payment processing may be 2.5 hours. In one implementation, the healthcare provider may receive the same day payment, which may be provided as per normal settlement with a merchant. In one implementation, the card web application may provision proper level of approval as appropriate for internal authorization levels, which may be prescribed by a set of pre-stored rules.

In one implementation, a corporation bank (e.g., bank of America, etc.) may transfer funds via payment gateways to financial institutions 296a, BIN sponsors 296b for settlement between insurance provider and healthcare provider.

In further implementations, the HPP-Platform may introduce a loyalty program, and multiple wallets for open loop card use. In a further implementation, the HPP-Platform may introduce small claims insurance schemes for outpatient care where payment may be remitted through the HPP-Platform prepaid card.

In further implementations, the HPP-Platform may comprise operable modules, structures, apparatuses, and/or the like, including complete shared hardware deployed in three tier architecture—web servers, application servers, database servers with common storage; state of the art data center infrastructure to host the entire solution; system software licenses comprising of operating system, compilers, tools etc; complete network equipment and network infrastructure within the premises of PMU 283; data center facility; interchange gateway infrastructure (e.g., VisaNet, etc.); application software licenses; technology operations; monitoring and management of the hardware and associated system software; monitoring and management of the network infrastructure; monitoring and management of database; data backup management; monitoring and management of the application software; exception handling and escalation; email support and telephonic support; overall system uptime management and reporting; generation of card issuance file for card embossing & encoding; transaction and card history management; handling of queries from client company; generation of reports, MIS (client to define); SMS support (text message); web hosting; fee management, and/or the like.

In further implementations, the HPP-Platform may issue invoices to participating entities (e.g., user, healthcare providers, insurance provider, etc.) through a sponsoring bank, wherein account creation to be utilized for bill generation. These records may indicate number of card created, re-issued and or any maintenance if applicable.

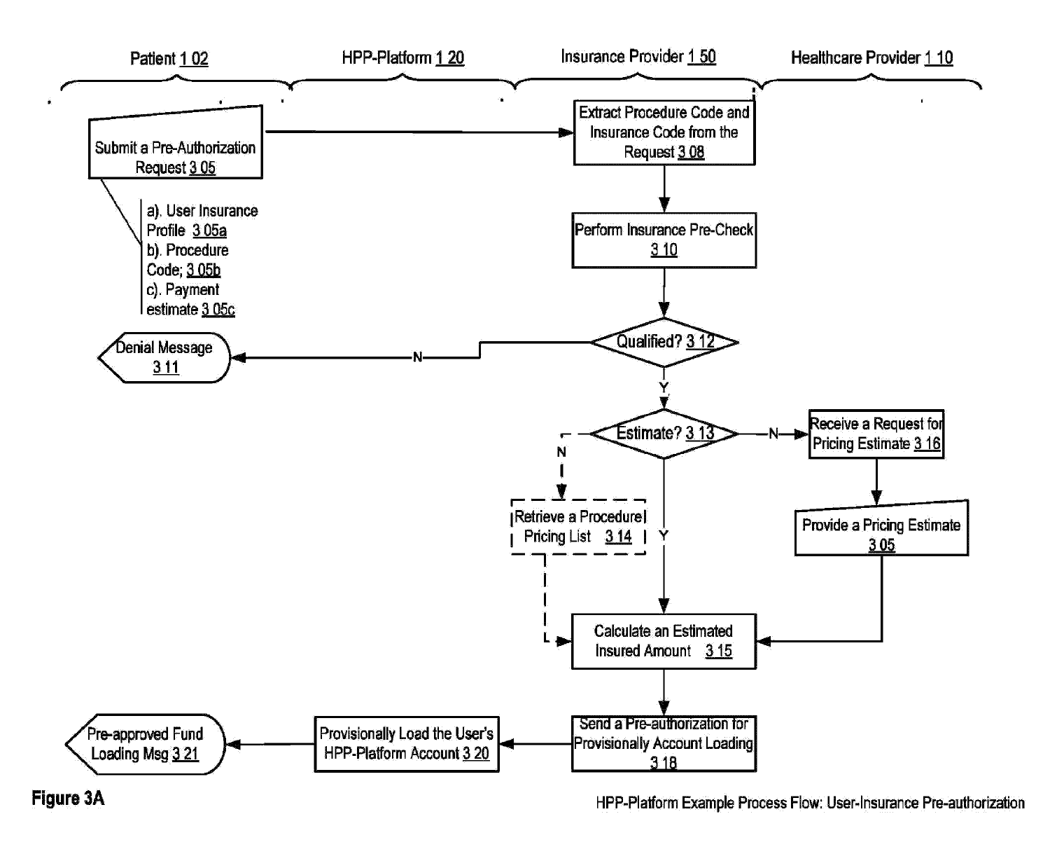

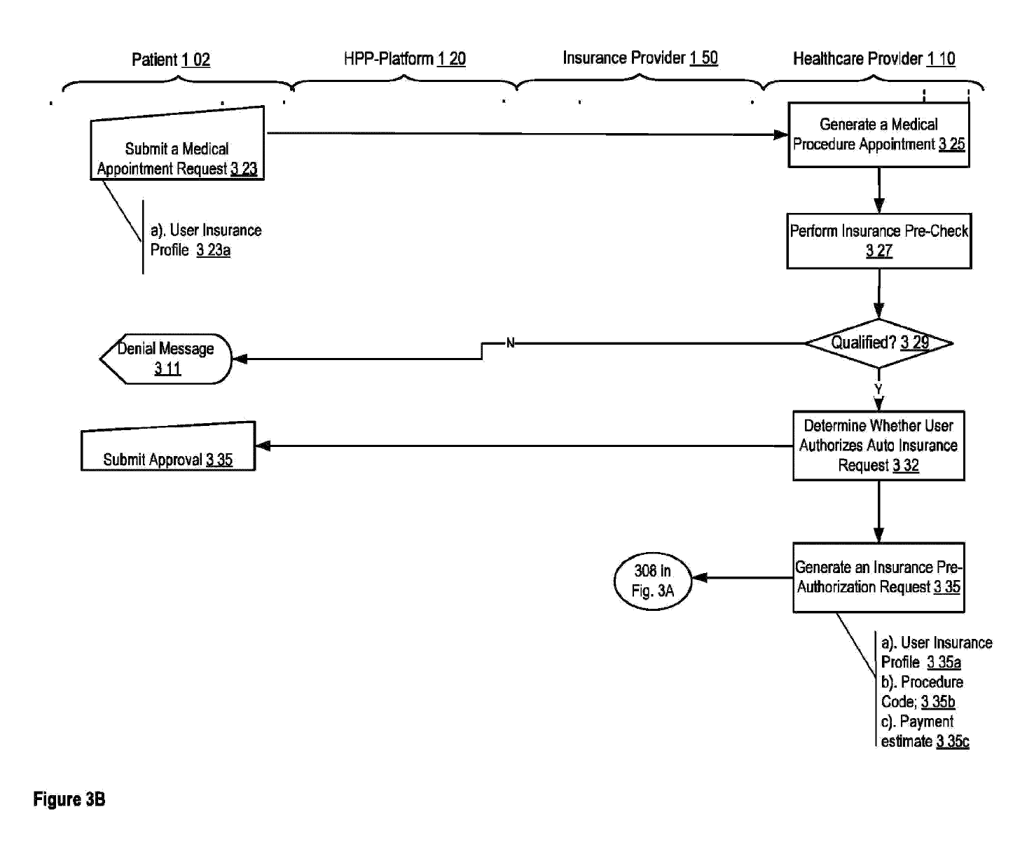

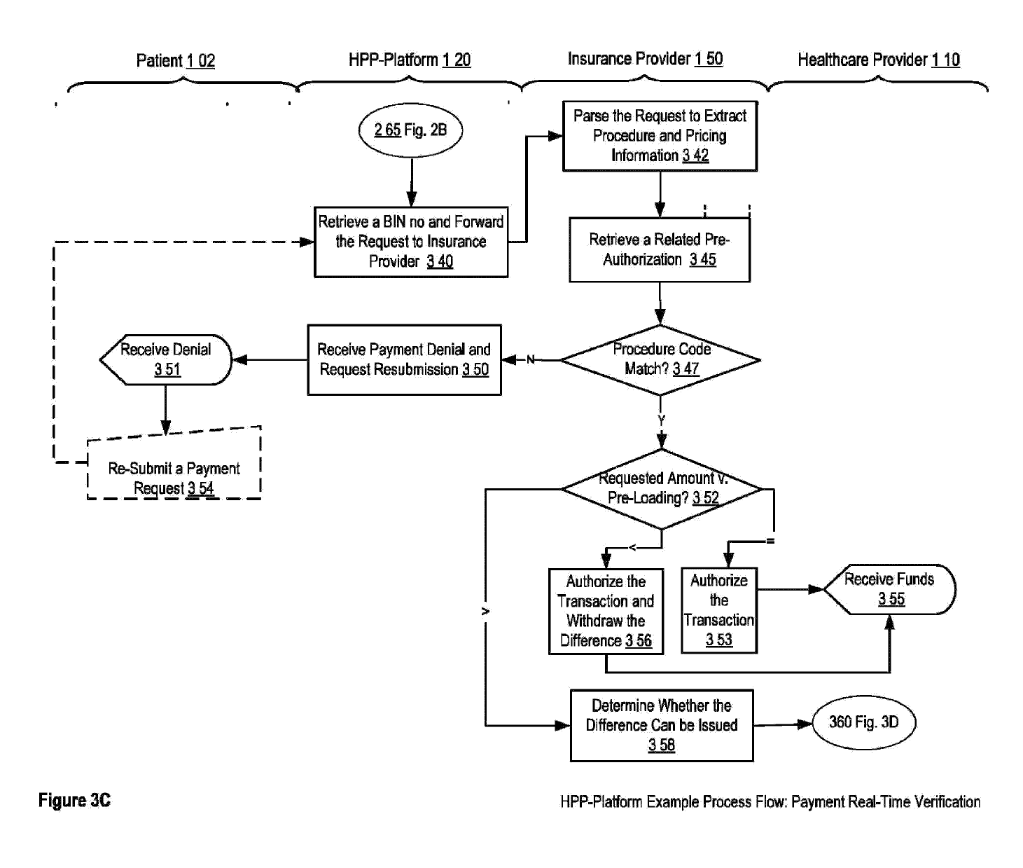

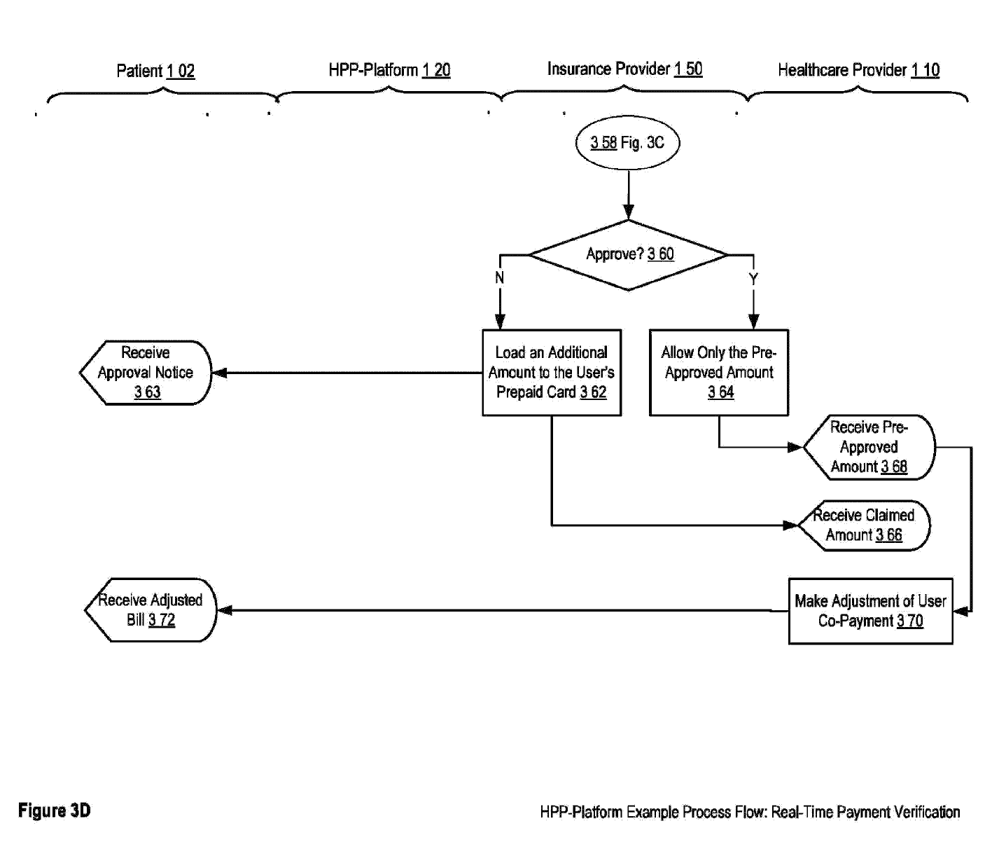

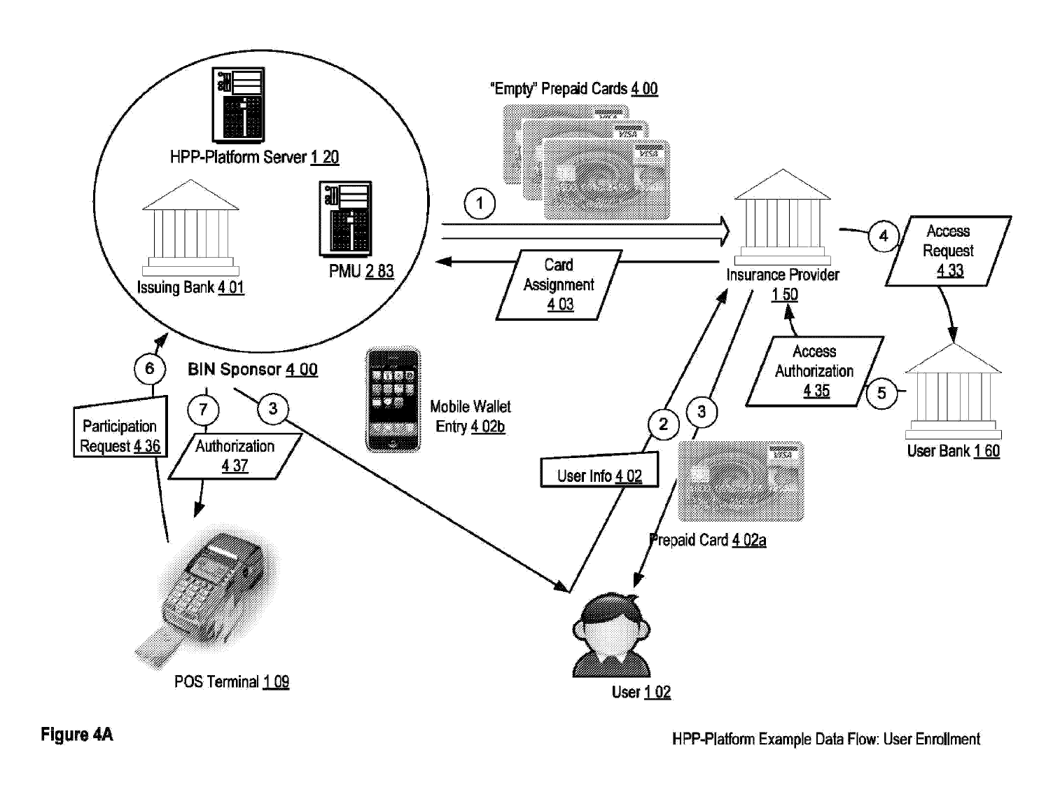

FIG. 3A provides a logic flow illustrating user-insurance pre-authorization within embodiments of the HPP-Platform. Within embodiments, the user may submit a pre-authorization request 305 to an insurance provider 150. For example, such request may comprise information such as user's insurance profile 305a, the scheduled healthcare procedure information including a procedure code 305b, a pricing estimate 305c, and/or the like. The user may furnish such information to the insurance provider in a variety of ways, such as making a phone call to an insurance representative, filling a pre-authorization form at a mobile/web portal (e.g., see FIG. 7), sending an email/text message, and/or the like. In a further implementation, the user may obtain an electronic appointment confirmation from the healthcare provider and may forward such electronic appointment confirmation message to the insurance provider. In a further implementation, the healthcare provider may attach a QR code at an appointment confirmation printout, and the user may snap a picture of the QR code and send it to the insurance provider, which may obtain the scheduled information embedded in the QR code.

Upon receiving the pre-authorization request, the insurance provider may extract information, such as a procedure code and an insurance policy code from the request 308. In one implementation, the insurance provider may perform an insurance pre-check based on the insurance policy 310 to determine whether user is qualified, e.g., whether the user has signed up for the HPP-Platform service, whether the user's insurance policy is eligible for the HPP-Platform service, and/or the like. If not, the user may receive a denial message 311.

Once the user is qualified 312, the insurance provider may determine whether there is a pricing estimate of the scheduled healthcare procedure 313 included in the request. For example, when a user manually filled in an online pre-authorization request form, he may not have knowledge of the pricing details. In such scenarios, the insurance provider may retrieve 314 stored pricing records associated with the scheduled healthcare provider and/or local healthcare providers to make an estimate. In another implementation, the insurance provider may contact the healthcare provider where the healthcare procedure is scheduled for pricing estimate 316 by providing the procedure code, and the healthcare provider may in turn provide a pricing estimate 305, e.g., a total amount of $12,000.00 for a knee surgery.

In one implementation, the insurance provider may then calculate an estimated insured amount 315 based on the pricing estimate and the user's insurance policy. For example, if the scheduled knee surgery requires a total amount of $12,000.00, and the user's insurance policy has a maximum cap of $5,000.00 for general surgeries, the insurance provider may determine the insured amount that can be re-authorized is $5,000.00. The insurance provider may send a pre-authorization message for provisionally account loading 318 to the HPP-Platform. In further implementations, the insurance provider may include a restriction requirement with the provisional loading, e.g., the funds may only be accessed via a terminal at the scheduled healthcare provider, at the scheduled date, and/or the like.

In one implementation, the HPP-Platform may provisionally load the user's HPP-Platform account 320, and send a pre-approved fund loading message 321 to the user, e.g. via automatic phone calls, email, text messages, and/or the like.

FIG. 3B provides a logic flow illustrating auto-submitted pre-authorization with an alternative embodiment of the HPP-Platform. In one embodiment, the user may schedule a healthcare procedure appointment with the healthcare provider, e.g., the doctor at a hospital orders and schedules a knee surgery for the user. The user may submit the appointment request 323 by submitting his patient profile, insurance profile 323a, and/or the like to the healthcare provider 110, which may in turn generate a medical procedure appointment 325. Once the appointment is made, the healthcare provider may run an insurance pre-check of the user 327 to determine whether the user and/or his insurance provider are qualified for a pre-authorization service 329. If not, the user may obtain a denial message 311, e.g., being notified by the healthcare provider that no pre-authorization request can be made due to the user's unqualified status.

If the user is qualified 329, the healthcare provider may determine whether the user authorizes the healthcare provider to automatically submit an insurance pre-authorization request 332 on the user's behalf. For example, the user may request the healthcare provider to do so 335. Upon user approval, the healthcare provider may generate an insurance pre-authorization request 335, and proceed with 308 in FIG. 3A. For example, the authorization request message may take a similar form to the message generated by the user, including information such as user insurance profile 335a, procedure code 335b, payment estimate 335c, and/or the like.

FIGS. 3C-3D provide logic flows illustrating insurance payment verification within embodiments of the HPP-Platform. Within embodiments, upon receiving a payment request using pre-loaded insurance funds, the HPP-Platform may retrieve a BIN number from the request and determine an insurance provider based on the BIN, and forward the request to the insurance provider for verification 340. The insurance provider may parse the request to extract information such as the related pre-authorization ID, procedure code, requested payment amount 342, and/or the like. The HPP-Platform may retrieve a related pre-authorization record based on the pre-authorization ID 345, and determine whether the procedure code included in the payment request matches with the procedure code submitted in the pre-authorization request 347. If the procedure code does not match, e.g., the procedure code in the payment request indicates a “vascular surgery” but the pre-authorized procedure is a “knee surgery,” the insurance provider may deny the payment and the HPP-Platform may request the user to verify the request and/or resubmit the request 350. In another implementation, the HPP-Platform may direct the payment request to an inspection unit for fraud alert investigation. In one implementation, upon receiving a denial 351 (e.g., the payment fails to go through at the POS terminal of the healthcare provider), the user may re-submit the payment request 354 to restart the process.

In another embodiment, if the procedure code matches 347, the insurance provider may proceed to check whether the requested amount matches the pre-approved amount 352. In one implementation, if the two amounts match strictly, the insurance provider may authorize the transaction using pre-approved funds for insurance payment 353, and the healthcare provider 355 may receive a payment immediately. In another implementation, when the two amounts do not match, the insurance provider may permit a tolerance level of difference, or may require further verification to approve the transaction having a different insured amount. For example, in one implementation, if the requested payment is less than the pre-approved amount, the insurance provider may authorize the transaction and withdraw the surplus amount 356. In another implementation, if the requested payment is greater than the pre-approved amount, the insurance provider may determine whether the additional amount can be issued 358. Rules may apply tolerances for any number of field values, which may include cost, procedure subject matter/category, date and time for the service/procedure performed, medication/procedure type, and/or the like.

For example, the insurance provider may apply tolerance rules to compare information in the pre-authorization request prior to the procedure and the actual payment request on the day of healthcare procedure, as illustrated in the exemplary example below:

| | | Pre-Authorization | Actual Payment | | |
|---|---|---|---|---|---|
| | | Request | Request | Tolerance Level | Status |
| User | Name | John Smith | John Smith | 1~2% | Approve |
| | DoB | 12/12/1960 | 12/12/1960 | 0% | Approve |
| | SSN | 111-00-0001 | 111-00-0001 | 0% | Approve |
| | . . . | . . . | . . . | . . . | . . . |
| Procedure | | Surgery | Surgery | 5~10% | Approve |
| Category | | | | | |
| Procedure Code | | KS0001 | KS0001 | 1~2% | Approve |
| Procedure | | Local X rays scan | General X rays | 5-10% | Further |
| description | | and left Knee | scan and left | | inspection |
| | | Surgery | knee surgery | | |
| . . . | | . . . | . . . | . . . | . . . |
| Date | | 09-09-2011 | 09-10-2011 | ±48 hours | Approve |
| Cost | Total | 12,000.00 | 12,456.32 | ±5% | Approve |
| | Insured | 5,000.00 | 7,600.00 | ±2% | Denied |
| | Co-Pay | 7,000.00 | 5,456.32 | NA | NA |
| | . . . | . . . | . . . | . . . | . . . |

In the above example, the tolerance levels of difference between information in the pre-authorization request prior to the procedure and the actual payment request on the day of healthcare procedure may vary. For example, the user information may have a strict tolerance level such that the user profile should be consistent to prevent identity theft and fraudulent medical claims. The insurance provider may allow some tolerance level in the difference of procedural code, date of service, so that flexibility may be allowed in the procedure treatment. In case significant inconsistency is captured in the procedure description, e.g., “general X rays” performed versus “local X rays” as scheduled, the insurance provider may direct the payment request to further inspection instead of real time approval. For another example, as the requested insured payment amount is more than “2%” greater than the estimated insured amount, the insurance provider may deny the payment request, e.g., only allowing payment of the pre-authorized amount, and may direct it to further inspection.

Continuing on with FIG. 3D, in one implementation, the insurance provider may approve 360 the additional amount, and load an additional amount to the user's prepaid card 362, wherein the additional amount equals the difference between the requested amount and the pre-approved amount. In that case, the user may receive an approval notice notifying the loading of the additional amount 363. and the healthcare provider may receive the full claimed amount 366. In another implementation, the insurance provider may not review and approve the additional amount in real time (e.g., the insurance provider may need extra time to review the request and investigate the pricing structure, etc.), and may leave the issue to adjudication afterwards. Thus the insurance provider may allow payment using only the pre-approved amount 364 so that the healthcare provider may receive a pre-approved amount 368 which is less than the claimed amount. In one implementation, the healthcare provider may obtain the difference during adjudication process. In another implementation, the healthcare provider may make adjustment of user co-payment 370, e.g., by adding the unpaid insured amount to the user responsible portion, etc. In that case, the user may receive an adjusted bill 372 reflecting the adjusted user co-payment amount.

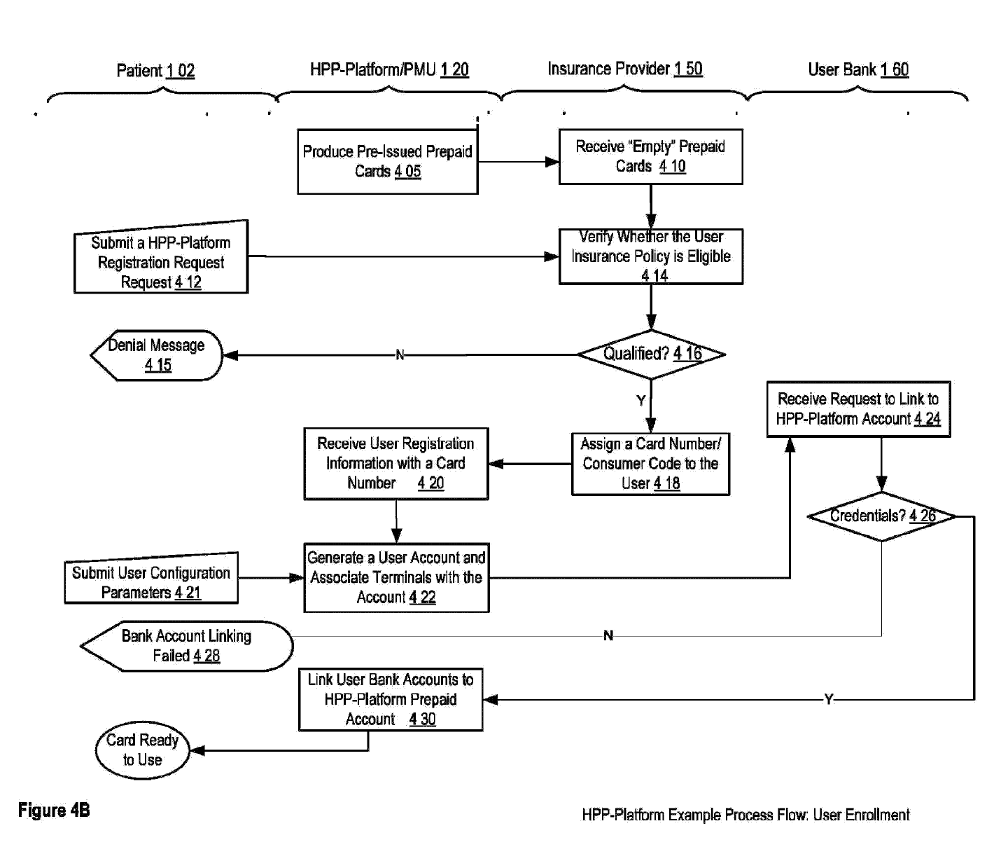

FIGS. 4A-4B provide a data flow and a logic flow illustrating HPP-Platform user enrollment within embodiments of the HPP-Platform. As shown in FIGS. 4A and 4B, within embodiments, the HPP-Platform server 120, or any issuing bank 401 (e.g., Bank of America, Chase, and/or the like), or the PMU 283 may act as a BIN sponsor 400 and issue a plurality of “empty” prepaid cards 400, each associated with a pre-determined card number and/or consumer code. For example, as shown in FIG. 4B, the HPP-Platform or the PMU may order the card production 405 including card embossing, card number creation, etc., and the insurance provider 150 may receive the produced “empty” prepaid cards 410.

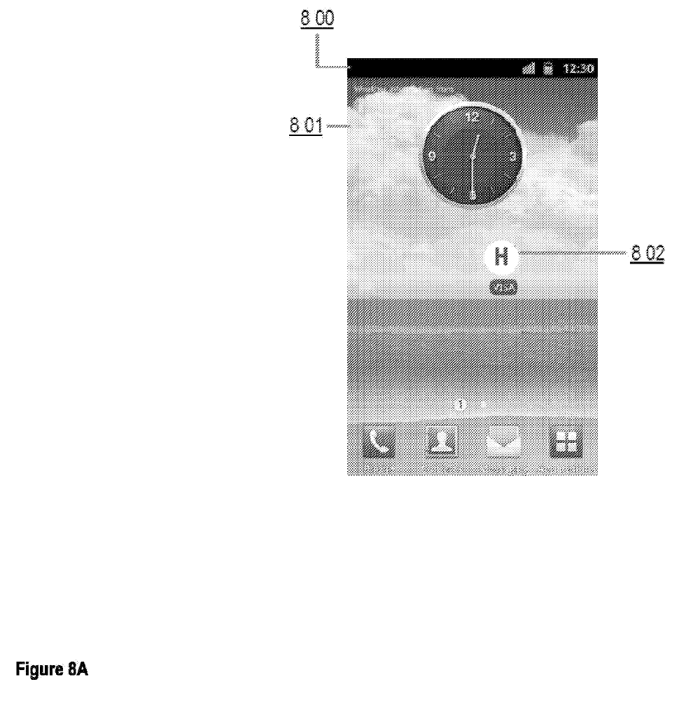

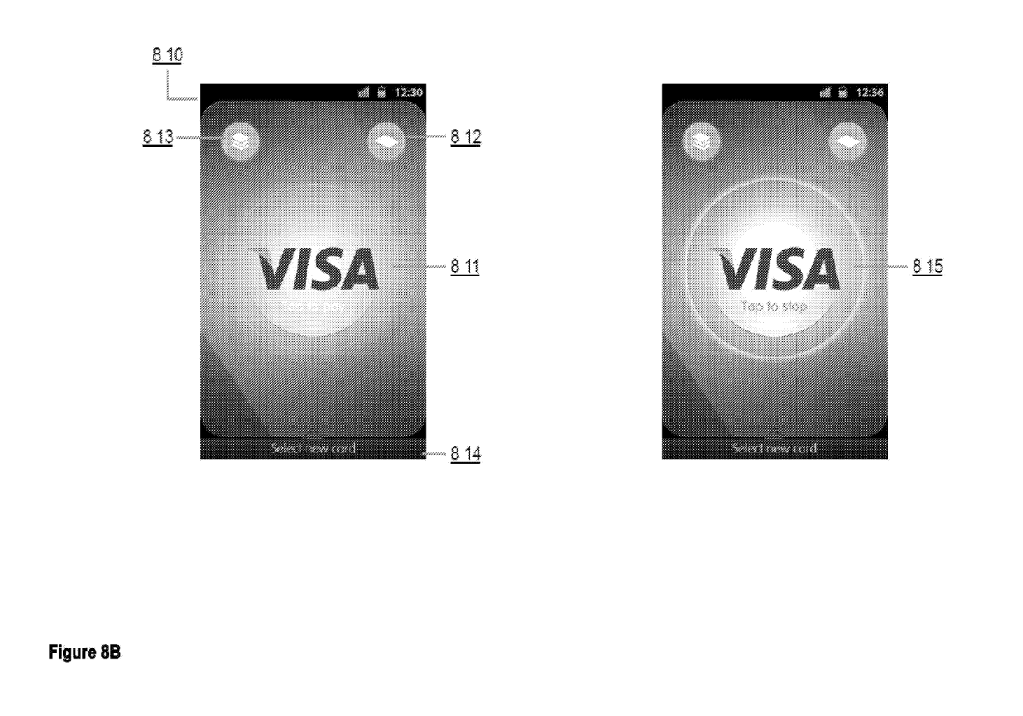

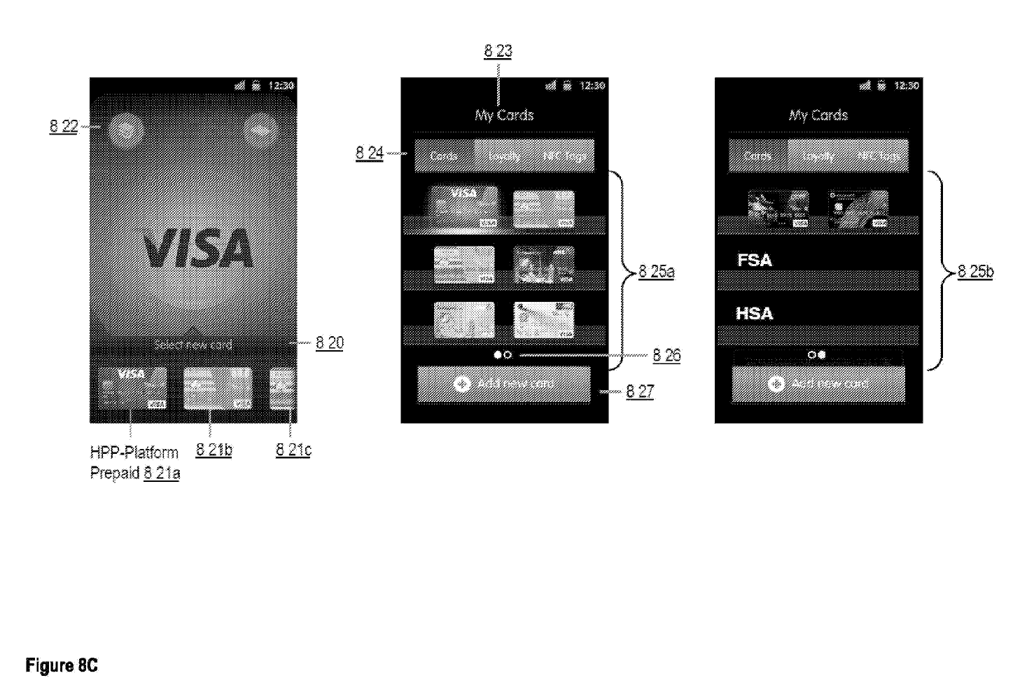

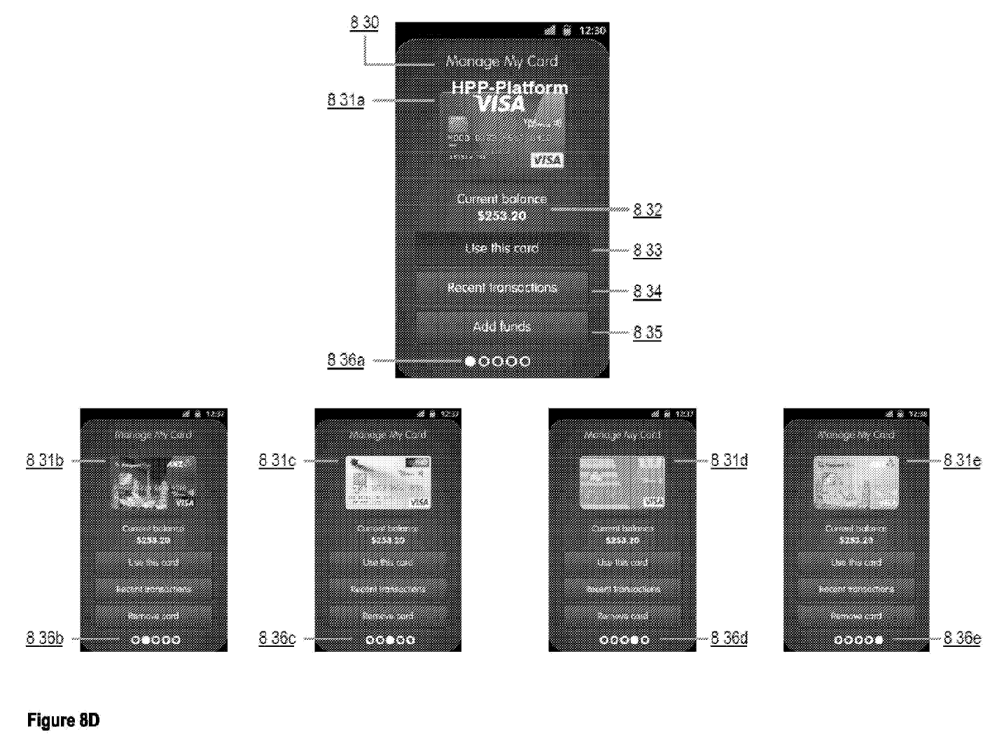

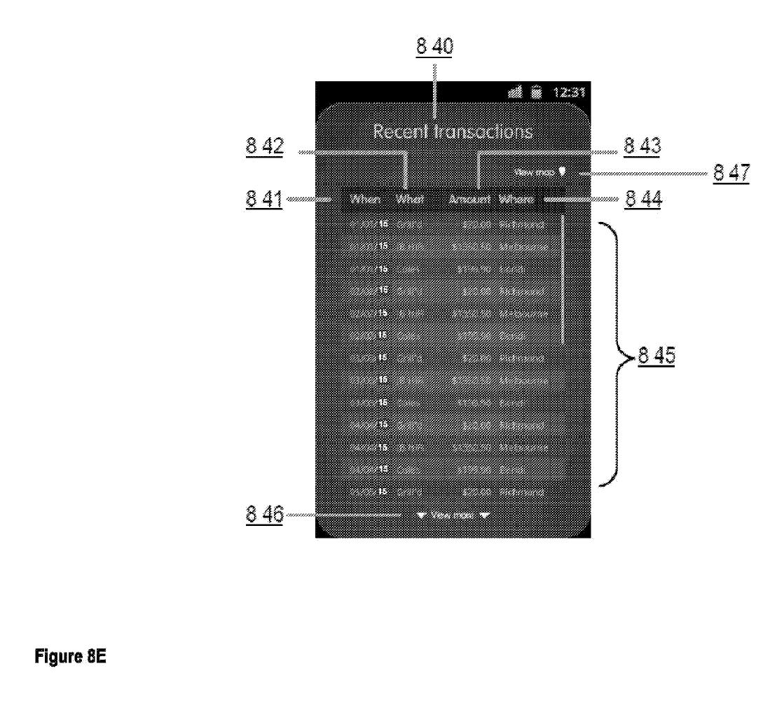

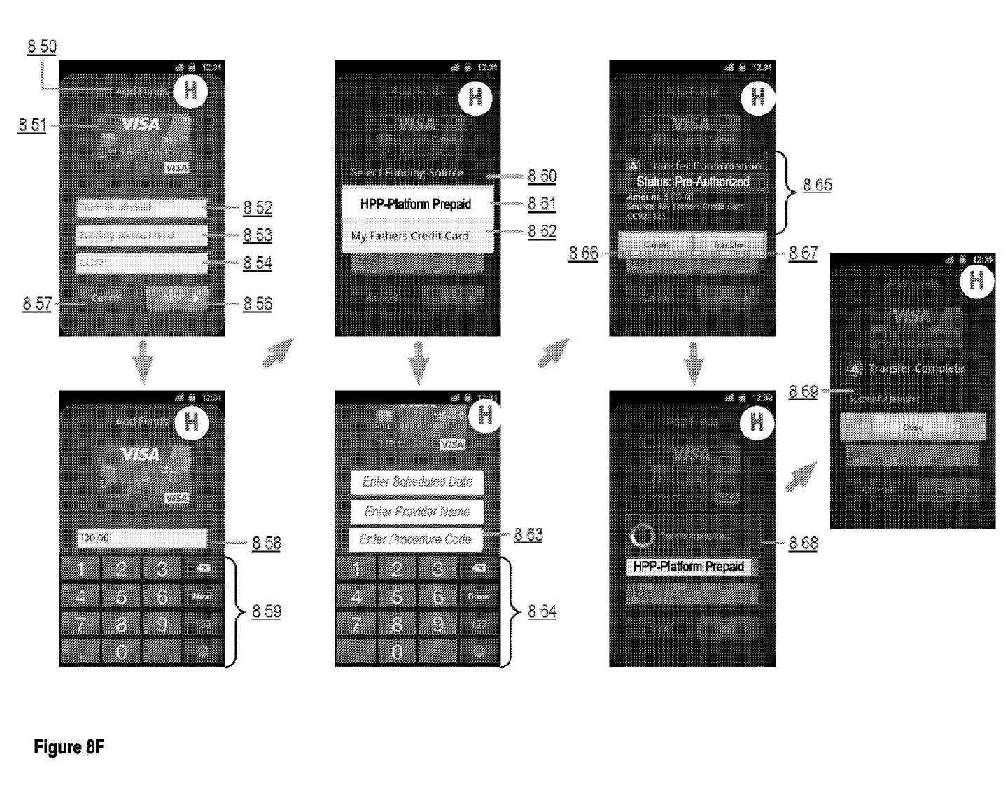

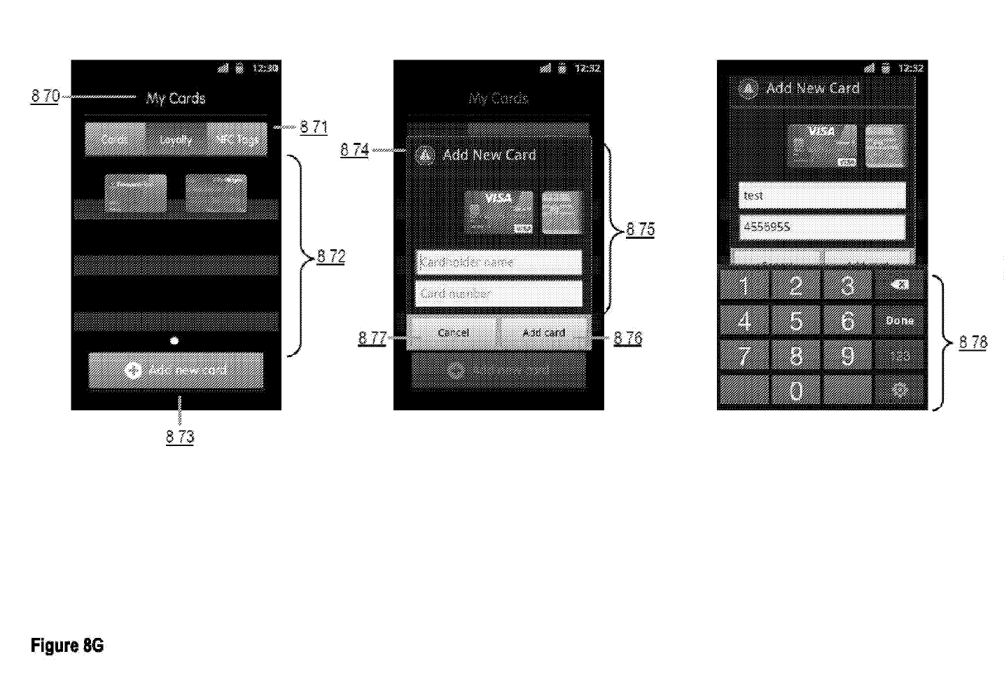

In another implementation, the HPP-Platform may provide virtual prepaid card including a card number without sending physical magnetic cards, e.g., an electronic mobile wallet entry 402b for the user to download, and may provide the insurance provider information as to the user registration including a virtual prepaid card number (e.g., see healthcare wallet component 802 in FIG. 8A). For example, in further implementations, an additional wallet may be created for general spends. Funds on the additional wallet may be separately loaded by the cardholder. The “Claims Settlement” wallet may be automatically utilized for payments for approved claims. Cardholders may have the option to utilize their “general purpose” wallet for out-of-pocket expenses at the hospitals as well as general spend at all HPP-Platform accepting merchant locations. In one implementation, the HPP-Platform prepaid account may be built into the general purpose wallet as a wallet entry (e.g., see 402b in FIG. 4A), debiting of funds from the general purpose or the healthcare claims wallet may be seamless to the cardholder. Use of the HPP-Platform wallet entry to pay for purchases may be accepted or denied by the system based on the merchant category code and terminal IDs.

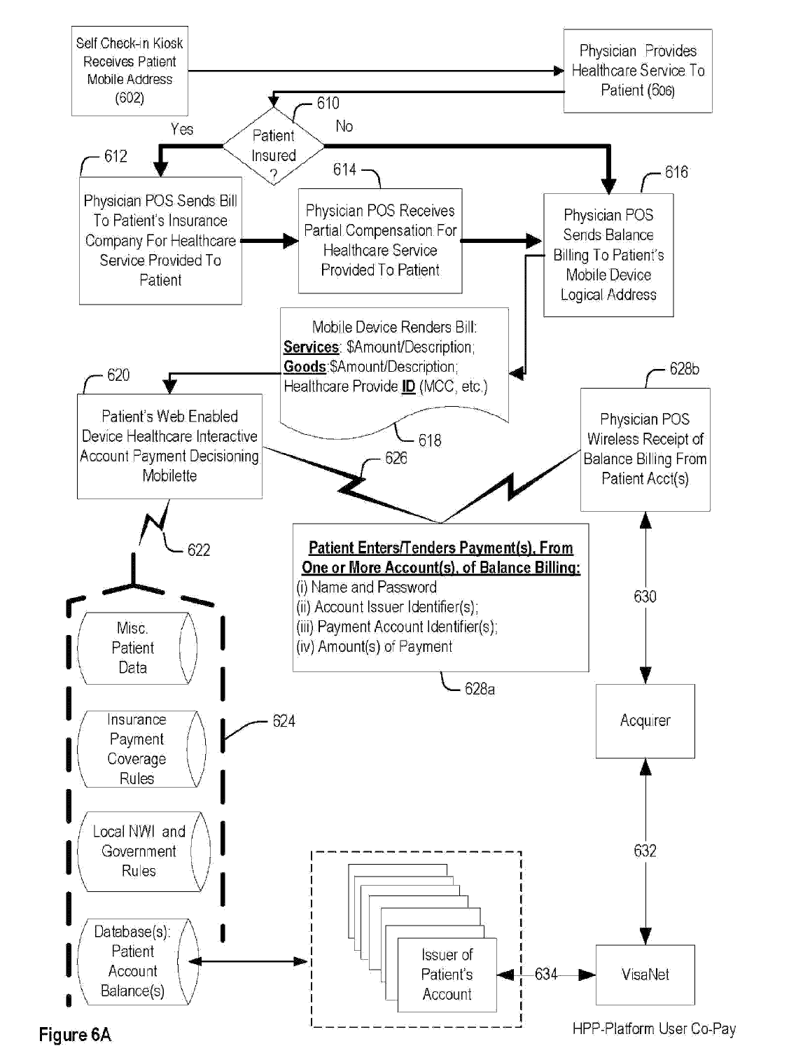

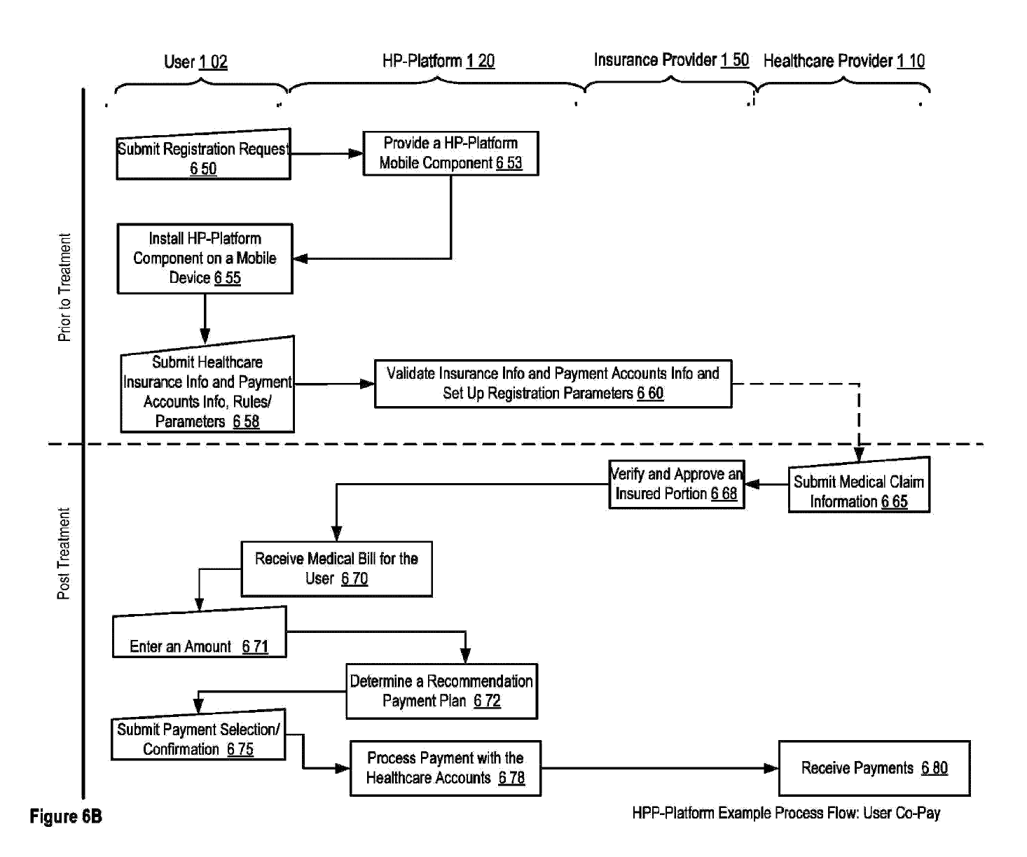

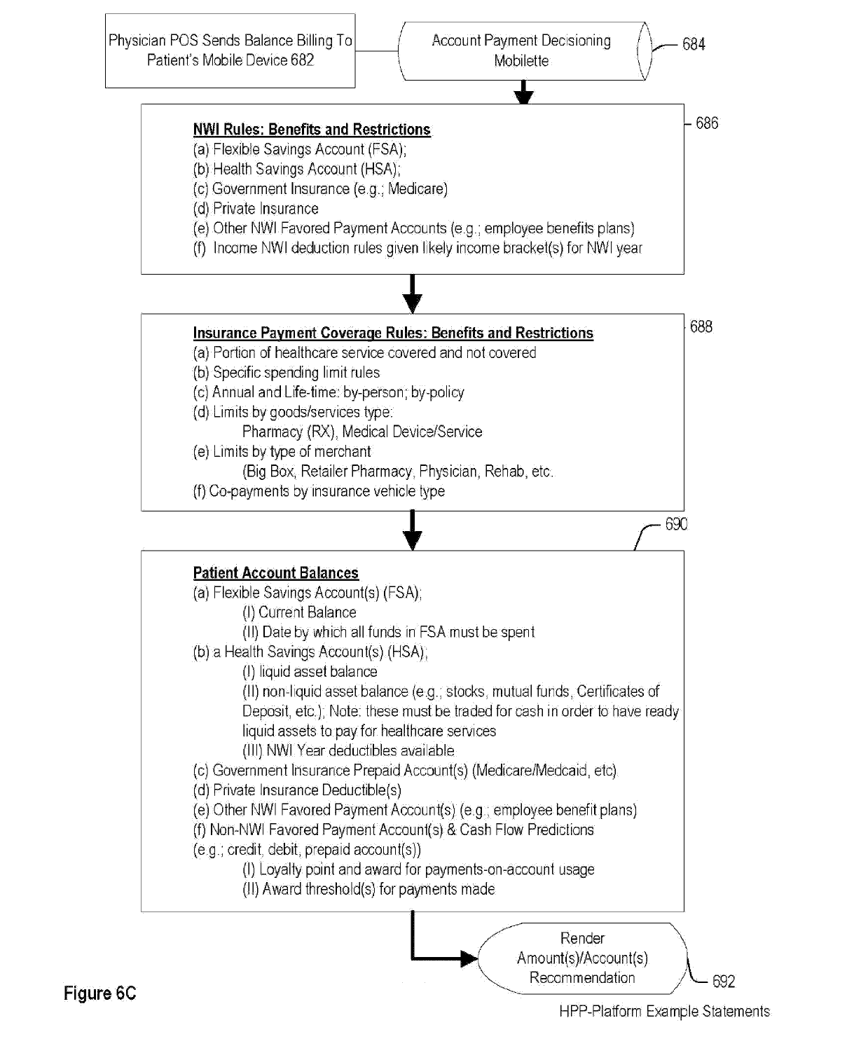

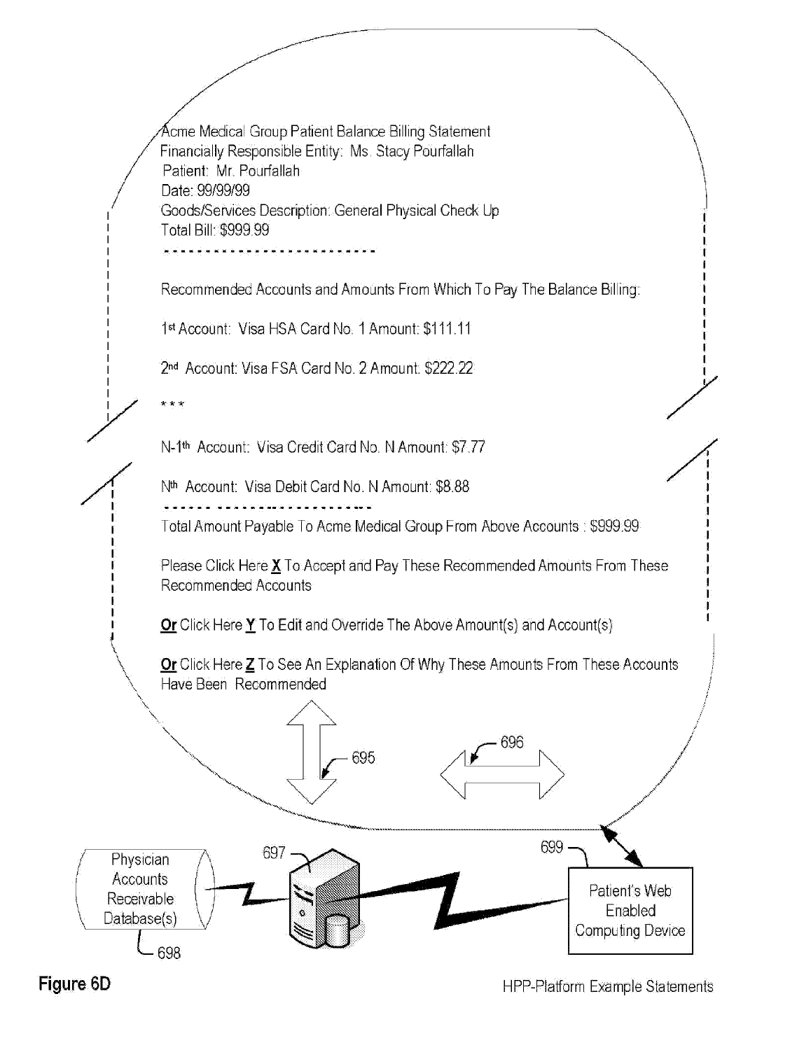

Within implementations, a user may fund his prepaid account in a way similar to funding of general purpose wallet, e.g., multiple funding mechanisms to be set up including automatic funding from debit or credit card account or voucher based loads at physical merchant locations. If cards are sold and distributed through companies, salaries could also be loaded to this general purpose wallet. The user may further link various accounts into the wallet for user co-pay, as further discussed in FIGS. 6A-6D.

Continuing on with FIG. 4A, the user may submit user information 402 to the insurance provider, requesting registration with HPP-Platform, e.g., at 412 in FIG. 4B. For example, the user may fill in an online application form, may call up an insurance agent, may send a request via instant messages, emails, and/or the like. In another implementation, the insurance provider may provide the option to register with HPP-Platform service when the user enrolls in an insurance policy. For example, an XML-formatted user registration request including user information 402 may take a form similar to the following:

```
POST /RegistrationRequest.php HTTP/1.1
Host: 255.25.000.0
Content-Type: Application/XML
Content-Length: 718
<?XML version = “1.0” encoding = “UTF-8”?>
<RegistrationRequest>
<Time> 17:42:40 </Time>
<Date> 09-01-2011 </Date>
<RequestType> Pre-Authorization Service </RequestType>
<RequestID> JS09012011 </RequestID>
<User>
        <UserName> John Smith </UserName>
        <UserID> JS0000 </UserID>
        <AccountNo> 0000 0000 0000 </AccountNo>
        <Password> 0000 </Password>
        <PasswordQ>
            <Question1> Where were you born </Question1>
            <Answer1> New York </Answer1>
            ...
        </PasswordQ>
        <Phone>
            <Cell> 000-000-0000 </Cell>
            <Day> 111-111-1111 </Day>
        ...
        </Phone>
        <Address>
            <Line1> 122 Apple Ave </Line1>
            <City> Big City </City>
            <State> CA </State>
            <ZipCode> 99920 </Zipcode>
        </Address>
        ...
</User>
<Insurance>
        <InsuranceID> BB0008PPO </Insurance>
        <InsuranceType> Regular </InsuranceType>
        <InsuranceCoverage>
            <ProcedureCode1> 60% </ProcedureCode1>
            <ProcedureCode2> 60% </ProcedureCode2>
            ...
</Insurance>
    ...
</RegistrationRequest>
```

For another implementation, the user registration request may take a form of a CSV file, which may be similar to the following:

| | | | | | | | |
|---|---|---|---|---|---|---|---|
| Field Name | Customer Id | Welcome Pack | Amount | Amount Received | Exchange Rate | Amount Loaded | Payment Mode |
| | | RefNo | Receiving | | | | |
| Length | 20 | 20 | 3 | 25 | 6 | 25 | 4 |
| Type | AN | N | A | Numbe and Decimal | Numbe and De [symbol] | Numbe and Deci$ | A |
| Business Rules | Not Null | Not Null for Non- | Not Null | Not Null | Not Null | Not Null | Null |
| | | Personalized/Null | | | | | |
| | | for Personalized | | | | | |
| PMU COMMENTS | Mandatory | Mandatory/Non | Mandatory | Mandatory | Mandatory | Mandatory | Non Mandatory |
| | | Mandatory | | | | | |

| | | | | | |
|---|---|---|---|---|---|
| REGISTRATION_2012 99870366202 | 000000000042 | INR | 1000.00 | 1.0000 | 1000.00 |
| REGISTRATION 2012 99870366203 | | INR | 0.00 | 1.0000 | 0.00 |

[symbol]

indicates data missing or illegible when filed

As shown in FIG. 4B, upon receiving “empty” prepaid cards (or virtual card numbers), and a user's registration request 412, the insurance provider 150 may verify whether the user's insurance policy is eligible for HPP-Platform registration 414. For example, the insurance policy may have restrictions on the eligibility of different insurance policies. If the insurance policy is not qualified for HPP-Platform registration, the user may receive a denial message 415. Alternatively, if it is qualified 416, the insurance provider may assign a card number/consumer code of an “empty” card to the user 418, and mail the prepaid card 402 to the user, e.g., 402a in FIG. 4A. For example, the insurance provider may generate a HTTPS POST message to make a database record in the form of data formatted according to the XML. Below is an example HTTP(S) POST message including an XML-formatted message of the card assignment message 403 for the HPP-Platform server:

```
POST /CardAssignment.php HTTP/1.1
Host: 255.25.222.0
Content-Type: Application/XML
Content-Length: 718
<?XML version = “1.0” encoding = “UTF-8”?>
<CardAssignment>
    <Time> 17:42:48 </Time>
    <Date> 09-01-2011 </Date>
    <RegistrationType> Pre-Authorization Service
    </RegistrationType>
    <RegistrationID> JS09012011 </RegistrationID>
    <AccountNumber> 0000 0000 0000 0000 </AccountNumber>
    <AccountType> Prepaid Visa </AccountType>
    <AvailableFunds> 0.00 </AvailableFunds>
<User>
    <UserName> John Smith </UserName>
    <UserID> JS0000 </UserID>
    <AccountNo> 0000 0000 0000 </AccountNo>
    <Password> 0000 </Password>
    <PasswordQ>
        <Question1> Where were you born </Question1>
        <Answer1> New York </Answer1>
    ...
    </PasswordQ>
    <Phone>
        <Cell> 000-000-0000 </Cell>
        <Day> 111-111-1111 </Day>
    ...
    </Phone>
    <Address>
        <Line1> 122 Apple Ave </Line1>
        <City> Big City </City>
        <State> CA </State>
        <ZipCode> 99920 </Zipcode>
    </Address>
    ...
</User>
...
</CardAssignment>
```

In another implementation, upon receiving registration information 402, the HPP-Platform may issue a HPP-Platform vehicle, e.g., a Visa prepaid card to the user 102. For another example, HPP-Platform may provide mobile applications for the user to download, and use the mobile application as a HPP-Platform vehicle, e.g., an Android application, iPhone application, etc. For another example, the HPP-Platform vehicle may comprise a virtual payment card, e.g., an additional entry 402b on the user's 102 electronic wallet, wherein the entry may comprise account information, user verification information, and/or the like that may prompt the user to provide additional payment method into the electronic wallet, e.g., adding a HPP-Platform payment account, etc (see FIGS. 8C-8D). In one implementation, the HPP-Platform virtual prepaid card, e.g., the mobile wallet entry 204b including the payment account entry, may take a form similar to the following XML-formatted data message:

```
<HPP-Platformentry>
    <UserName> John Smith </UserName>
    <UserID> JS0000 </UserID>
    <UserContactNo> 000 000 0000 </UserContactNo>
    <Password> 0000 </Password>
    <PasswordQ>
        <Question1> Where were you born </Question1>
        <Answer1> New York </Answer>
        ...
    </PasswordQ>
    <Insurance>
    <InsuranceID> BB0008PPO </Insurance>
    <InsuranceType> Regular </InsuranceType>
    <InsuranceCoverage>
        <ProcedureCode1> 60% </ProcedureCode1>
        <ProcedureCode2> 60% </ProcedureCode2>
        ...
    </Insurance>
    ...
    <DefaultAccount>
        <AccountType> HPP-Platform prepaid </AccountType>
        <AvailableFunds> 500.00 </AvailableFund>
            ...
    </DefaultAccount>
    <AllowOtherAccounts> Yes </AllowOtherAccounts>
    </PaymentAccount>
    <Certificate>
        <UserToken> fdsjreiorrgr8t9340548 </UserToken>
        </DigitalCertificate> rfsfsuifuisduifu </DigitalCertificate>
        <Hash> 00000 </Hash>
        ...
    </Certificate>
...
</HPP-Platformentry>
```

Continuing on with FIG. 4B, upon receiving user registration information with card number assignment 420, the HPP-Platform may generate a user account and associate a list of terminal codes with the user account 422. For example, the insurance provider may provide restriction requirement that pre-authorized insurance funds could only be triggered for healthcare payment at a list of authorized healthcare providers. The insurance provider may provide a list of POS terminal codes to the HPP-Platform so that the user's HPP-Platform prepaid card may only be accepted for payment at the POS terminals of the associated healthcare providers, e.g., the user may not use a prepaid card with pre-loaded funds to engage in arbitrary purchases such as food, clothing, etc.

In an alternative implementation, the user may submit configuration parameters 421 for the HPP-Platform account. For example, the user may set a maximum amount for a one-time transaction (e.g., $5,000.00, etc.). For another example, the user may restrict the frequency of card activity, e.g., no more than twice per day, and/or the like. Such parameters may be associated with the user account record.

In one implementation, upon user registration, the HPP-Platform may link the created user HPP-Platform vehicle (e.g., the prepaid card, a mobile application, etc.) associated with the user HPP-Platform account with a variety of user bank accounts, and/or user account associated with an insurance provider. For example, the user may provide his bank account number, bank routing number of one or more of his checking account, saving account, credit card account, and/or the like to the HPP-Platform. For another example, the user may provide his user credential (e.g., user name, password, insurance number, and/or the like) of his insurance account login to the HPP-Platform. For a further example, the user may provide alternative payment credentials to HPP-Platform, such as PayPal account name, etc (e.g., see the electronic wallet in FIGS. 8A-9B).

Within implementations, a user's bank 16 may receive a request (e.g., the access request 433 in FIG. 4A) to link to HPP-Platform account 424. For example, the HPP-Platform may generate a HTTPS POST message to the user's bank (e.g., based on the user provided user bank routing number) in the form of data formatted according to the XML. Below is an example HTTP(S) POST message including an XML-formatted message of the access request message 403 for the HPP-Platform server:

```
POST /AccessRequest.php HTTP/1.1
Host: 255.25.222.0
Content-Type: Application/XML
Content-Length: 718
<?XML version = “1.0” encoding = “UTF-8”?>
<AccessRequest>
    <Time> 17:42:52 </Time>
    <Date> 09-01-2011 </Date>
    <RegistrationID> JS09012011 </RegistrationID>
    <BankAccount>
        <AccountNo> 1111 1111 1111 1111 </AccountNo>
        <RoutingNo> 111111 </RoutingNo>
        ...
    </BankAccount>
    <User>
        <UserName> John Smith </UserName>
        <UserID> JS0000 </UserID>
        <AccountNo> 0000 0000 0000 </AccountNo>
        <Password> 0000 </Password>
        <PasswordQ>
        <Question1> Where were you born </Question1>
        <Answer1> New York </Answer1>
        ...
    </PasswordQ>
    ...
</AccessRequest>
```

Within implementations, the user's bank may verify the credentials and authorize the access request from HPP-Platform. For example, the user bank 160 may determine whether user credentials 426, confirmation, etc. are received to indicate authorization from account owner. In one implementation, the user bank may provisionally make a small amount deposit into the account that HPP-Platform attempts to link to, e.g., $0.65, etc., and request the user enter the numeric value of the deposit to prove authorization. For example, the user may receive confirmation request via email, instant messaging, phone calls, text messages, wallet notices, and/or the like, to provide the deposited numeric value. If such credentials 426 are not received by the user bank within a specified time frame (e.g., 24 hours, etc.), the user may receive a notice that the bank account linking attempt fails 428. Otherwise, if credentials are received, the HPP-Platform may receive an access authorization response (e.g., 435 in FIG. 4A) from the user bank 160. For example, the user bank may generate a HTTPS POST message to the HPP-Platform server in the form of data formatted according to the XML. Below is an example HTTP(S) POST message including an XML-formatted message of the access authorization message 435 for the HPP-Platform server:

```
POST /AccessResponse.php HTTP/1.1
Host: 255.25.222.1
Content-Type: Application/XML
Content-Length: 718
<?XML version = “1.0” encoding = “UTF-8”?>
<AccessResponse>
    <Time> 17:50:23 </Time>
    <Date> 09-01-2011 </Date>
    <RegistrationID> JS09012011 </RegistrationID>
    ...
    <Credentials>
        <Value> 0.65 </Value>
        <Status> Good </Status>
        ...
    </Credentials>
    <BankAccount>
        <AccountNo> 1111 1111 1111 1111 </AccountNo>
        <RoutingNo> 111111 </RoutingNo>
        ...
    </BankAccount>
    <User>
        <UserName> John Smith </UserName>
        <UserID> JS0000 </UserID>
        <AccountNo> 0000 0000 0000 </AccountNo>
        <Password> 0000 </Password>
        ...
    </User>
    <Authorization> Yes </Authorization>
    ...
</AccessResponse>
```

Thus the HPP-Platform completes user enrollment after successfully link the user bank account to the HPP-Platform prepaid account 430, and the card, and/or mobile wallet entry is ready to use.

In further implementations, a healthcare provider may elect to participate/enroll with HPP-Platform. For example, the healthcare provider (and/or the POS terminal 109) may send a participation request 436 to the HPP-Platform, e.g., the BIN sponsor 400. For example, the POS terminal at the healthcare provider may generate a HTTPS POST message to the HPP-Platform server in the form of data formatted according to the XML. Below is an example HTTP(S) POST message including an XML-formatted message of the participation request message 436 for the HPP-Platform server:

```
POST /ParticiaptionRequest.php HTTP/1.1
Host: 255.25.222.8
Content-Type: Application/XML
Content-Length: 718
<?XML version = “1.0” encoding = “UTF-8”?>
<ParticipationRequest>
    <Time> 17:50:23 </Time>
    <Date> 09-03-2011 </Date>
    <RequestID> STH0002</RequestID>
    <TerminalID>
        <ID1> STHG-00-00-TX </ID1>
        <ID2> STHG-00-00-TG </ID2>
        ...
    </TerminalID>
    <Provider>
        <ProviderID> STHG-CA-001 </ProviderID>
        <Name> St Paul Hospital </Name>
        <Address> 35 Apple Drive, CA 99940 </Address>
        ...
    </Provider>
    ...
</ParticipationRequest>
```

In one implementation, the HPP-Platform may verify the request to determine whether the source entity of the request qualifies for the participation (a non-healthcare provider may not qualify, e.g., POS terminals at a department store, a hotel, etc.) and accept the enrollment of the healthcare provider and send a terminal token 437. Upon registration, the user's HPP-Platform prepaid card may be acceptable at the POS terminal at the healthcare provider.

In one implementation, the HPP-Platform may generate a CSV file including a list of terminal IDs that have registered with the HPP-Platform and can accept payment from the HPP-Platform prepaid account. An exemplary CSV record of the terminal ID may take a form similar to the following:

| Current Format | MID | TID | Merchant Category | Merchant Name | Add/Delete | Group ID |
|---|---|---|---|---|---|---|
| Field Size | 15 | 8 | 4 | 20 | 1 | 6 |
| Type | Alphanumeric | Alphanumeric | Numeric | Alphanumeric | Alphabetic | Alphanumeric |
| Mandatory/Optional | M | M | M | O | M | M |
| TMID_201201090001 | 11254541 | 12045198 | 8062 | ShreeJeewan1234 | A | TID006 |
| TMID_201201090001 | 11254280 | 12043543 | 8062 | dalesMedicalCe1234 | A | TID006 |
| TMID_201201090001 | 50163252 | 43238657 | 8062 | MamtaHospital1234 | A | TID006 |
| TMID_201201090001 | 0000113105423 | 11318568 | 8062 | aHospitalPvt1234 | A | TID006 |
| TMID_201201090002 | 434534534 | 11318569 | 8062 | ABC Hospital | D | TID006 |
| TMID_201201090002 | 565463456 | 11318561 | 8062 | xyz hospital | D | TID006 |
| TMID_201201090002 | 345345 | 11318562 | 8062 | qpr hospital | D | TID006 |
| TMID_201201090002 | 534345342 | 11318563 | 8062 | ghi hospital | D | TID006 |

FIGS. 5A-5B provide logic flow diagrams illustrating post-payment adjudication within embodiments of the HPP-Platform. Within embodiments, the HPP-Platform may not require real-time verification and authorization by the insurance provider when a user triggered payment with pre-authorized funds, as described in FIGS. 3C-3D. Alternatively, the HPP-Platform may deposit the pre-authorized funds into the user's HPP-Platform account and the user may use the prepaid account as a debit card to pay healthcare related purchases, wherein the insurance provider, healthcare provider, and the HPP-Platform may engage in post-payment adjudication.

As shown in FIG. 5A, continuing on with 260 in FIG. 2B, wherein the insurance provider issues pre-authorized insurance funds in response to a user's submission of a scheduled healthcare procedure (e.g., $5,000.00 deposit into the prepaid account), the user may elect to load funds into his prepaid account 505. For example, when the user has a knee surgery scheduled, the estimated cost may comprise a total amount of $12,000.00 with an estimated insured amount of $5,000.00 and estimated user co-pay amount of $7,000.00. The insurance provider may deposit a pre-authorized amount of $5,000.00 into the user's prepaid account, and the user may elect to deposit a certain amount into his account as well to pay for the later incurred bill of $12,000.00.

In one embodiment, the HPP-Platform may add the loaded funds into the user's prepaid account as a debit deposit for use 510. On the day of the scheduled procedure, the user may submit a payment request 512, e.g., by swiping his prepaid card or engage his mobile wallet, etc. The healthcare provider may determine whether the prepaid card is acceptable at the POS terminal 513, e.g., whether the POS terminal has participated into the HPP-Platform payment service (e.g., see 436 in FIG. 4A). If not, the user may receive a denial message 515. If accepted by the POS 513, the HPP-Platform may receive the payment request, e.g., the user's prepaid card number, a requested payment amount, etc. The HPP-Platform may determine whether there is sufficient prepaid amount in the account 519. If yes, the HPP-Platform may deduct the requested payment amount from the prepaid account 520 and transfer the requested payment amount to the healthcare provider 527. In another implementation, when there is not sufficient funds in the prepaid account, e.g., there is only $5,000.00 pre-authorized by the insurance provider in the prepaid account, but the user submits a request to use the prepaid card to pay for a total amount of $12,000.00, the user may elect to split the payment and pay with other accounts 523. For example, the user may select other linked accounts from his mobile wallet to proceed with payment (e.g., as shown in FIGS. 9A-9B). In one implementation, the HPP-Platform may process the payment request and deduct the indicated amount from user selected accounts 525.

Upon completing the fund transfers from the user to the healthcare provider, the HPP-Platform may generate a transaction record 530 (e.g., see 166 in FIG. 1B).

Continuing on with FIG. 5B, adjudication may be initiated and/or requested 535 by the insurance provider and/or the healthcare provider. For example, in one implementation, the healthcare provider may not receive sufficient payment and may submit a medical claim 537 to the insurance provider for review and adjudication to see whether the insurance provider's pre-authorized funds to the user has covered the requested medical claim. For another example, the insurance provider may request to review the payment to see whether the payment matches with the scheduled healthcare procedure, and whether the paid pre-authorized funds matches the medical claim from the healthcare provider.

In one implementation, the insurance provider may receive a transaction record from the HPP-Platform and may extract information such as the procedure information 542, the related pre-authorization ID, payment amount, and/or the like. The HPP-Platform may then retrieve a related pre-authorization record based on the pre-authorization ID, and determine whether the procedure code included in the payment record matches with the procedure code submitted in the pre-authorization request 547. If the procedure code does not match, e.g., the procedure code in the transaction record indicates the user had a “vascular surgery” but the pre-authorized procedure is a “knee surgery,” the insurance provider may direct the transaction details to HPP-Platform staff for further inspection to prevent fraudulent claims 548. The HPP-Platform may send a fraud alert message to the user to notify the inconsistency 550.

In another embodiment, if the procedure code matches 547, the insurance provider may proceed to check whether the requested amount matches the pre-approved amount 552. When the two amounts do not match, the insurance provider may permit a tolerance level of difference, or may require further investigation into the transaction having a different insured amount. For example, in one implementation, if the requested payment is less than the pre-approved amount, e.g., the insurance company has paid more than the healthcare provider has claimed for, the insurance provider may request a refund of the difference 556 from the healthcare provider. In another implementation, if the requested payment is greater than the pre-approved amount, the insurance provider may determine whether the additional amount can be issued 558. If yes, the insurance provider may transfer the adjusted amount to the healthcare provider 560. As such, the healthcare provider may receive payment of the difference, or a request for refund, respectively, 555.

For example, in one implementation, the HPP-Platform may generate a refund message in the form of CSV file, which may take a form similar to the following:

| Current Format | Product Code | Customer Id | Type Of | Amount | Exchange Rate | Amount | Amount Paid | Transaction |
|---|---|---|---|---|---|---|---|---|
| | | | Refund | Refund | | Paid [symbol] | | Id |
| Field Size | 6 | 20 | 7 | 25 | 6 | 3 | 25 | 20 |
| Type | AN | AN | A | Number | Number | A | Number and | N |
| | | | | and Dec [symbol] | and De [symbol] | | Decimal | |
| MandatoryOptional | Mandatory | Mandatory | Mandatory | Mandatory | Mandatory | Mandatory | Mandatory | Mandatory |
| Remarks | Product Code | 99870366202 | PARTIAL/ | | | | | |
| | Should already | | FULL/CLOSE | | | | | |
| | be defined | | | | | | | |
| | in the | | | | | | | |
| REFUND_2012010900 [symbol] | PRD001 | | PARTIAL | 2000.00 | 1.0000 | INR | 2000 | 9987036620 |

[symbol]

indicates data missing or illegible when filed

FIG. 5C provides a logic flow diagram illustrating post-payment reconciliation between the insurance provider and the healthcare provider within embodiments of the HPP-Platform. Within implementations, HPP-Platform may reconcile the insurance provider approved insured amount payment with the actual transacted amount made from the insurance provider to the healthcare provider. Part of the reconciliation process may be reflected in and combined with the post-payment adjudication discussed in FIGS. 5A-5B. For example, upon pre-authorizing and approving funds loading into the user's prepaid account, the insurance company may seek to verify whether the entirety of the pre-loaded funds are paid to the healthcare provider as insured amount, e.g., see 547-560 in FIG. 5B.

Alternatively, as shown in FIG. 5C, the HPP-Platform may retrieve financial transaction record to verify whether a healthcare provider has received a payment for insured amount matching up with the pre-authorized funds issued by the insurance provider. Within implementations, the HPP-Platform may retrieve payment transaction records 565 (e.g., 166 in FIG. 1B), and reconcile the transacted amount with the insurance provider's pre-approved amount and/or approved adjusted amount (e.g., see 558 at FIG. 5B) 568.

In one implementation, the HPP-Platform may reconcile the insurance payment amount in a financial transaction record (e.g., 166 in FIG. 1B) and the approved insurance amount in the authorization message (e.g., 136 in FIG. 1B) 568. If the two amounts match 570, the HPP-Platform may clear the transaction 573 and generate a transaction reconciliation report 575. Otherwise, if the amounts do not match 570, the HPP-Platform may flag the transaction for further inspection 576. For example, when the pre-approved amount is $5,000.00, but the transaction record shows an insured amount of only $4,500.00 was transacted from the user's prepaid account to the healthcare provider, the HPP-Platform may automatically determine the difference as $500.00, and send a notification to the parties (e.g., the insurance provider 150 and healthcare provider 110) indicating the difference. When the insurance payment adjustment is provided to the healthcare provider, the healthcare provider may generate a new medical bill for the user, e.g., may proceed in a similar manner as described at 370 in FIG. 3D.

In further implementations, the HPP-Platform may generate a transaction report 575 to the healthcare provider including the reconciliation status of the transaction for further inspection of the payment transaction 578. In one implementation, the healthcare provider may determine whether sufficient insurance payment has been made based on the report 580. For example, when the transacted amount equals the insurance provider authorized insured amount at 260 in FIG. 2B, the HPP-Platform may finish the reconciliation process. In another implementation, when the transacted amount is less than the insurance provider authorized insured amount, the healthcare provider may generate an additional payment request 581 to the insurance provider, which may in turn re-process the payment claim, e.g., in a similar manner starting at 537 in FIG. 5B. In another implementation, the transacted amount is greater than the insurance provider authorized insured amount, the healthcare provider 110 may provide a refund to the insurance provider 585.

In further embodiments, the HPP-Platform may be deployed in a variety of scenarios in similar manners, such as, but not limited to employee benefits administration and related payment processing, pharmaceutical drug sampling, direct to consumer programs, government administered healthcare/benefit programs, bill payment/recurring payments by patients/employees to benefit service providers, and/or the like. For example, the HPP-Platform may process and reconcile data for a government administered healthcare/benefit program with actual transacted amount from the government sponsor, and/or the like. In further implementations, the HPP-Platform may be deployed for drug sample, vaccine purchases, and/or the like.

FIG. 6A-6D provides combined data and logic flow diagrams illustrating alternative embodiments of user co-pay within embodiments of the HPP-Platform. As discussed in FIG. 4B, a user may enroll with HPP-Platform by linking various bank accounts for user payment with the prepaid account. In a further implementation, the user may ad negative wealth impactor accounts with the HPP-Platform accounts, such as Flexible Savings Accounts (FSA), one or more Health Savings Accounts (HSA), one or more government insurance programs (i.e., Medicare or Medicaid), various private insurance negative wealth impactor rules, various other negative wealth impactor favored payment accounts such as employment benefit plans or employee pharmacy benefit plans, and income negative wealth impactor deduction rules, and/or the like.

FIG. 6A provides a logic flow diagram illustrating processing healthcare payment within embodiments of the HPP-Platform. In one embodiment, the payment being made by the user is optimized for the user's benefit with respect to considerations of insurance, governmental taxation, and user data so that an optimized payment scheme to be made to satisfy a bill from the healthcare provider for the healthcare.

In one embodiment, a user may check in at a kiosk at a healthcare provider's office 602, e.g., a POS registry a hospital, a clinic, and/or the like. The physician or other healthcare provider may provide healthcare service to the user 606. In one embodiment, the physician's office determines whether or not the user is insured 610. If the user is insured, then process moves to step 612. Otherwise, the process moves to step 616.

In one implementation, the physician's Point Of Service terminal (POS) may send a bill to the user's insurance company for the healthcare that was provided to the user. For example, the healthcare provider may send the medical bill directly to an insurance provider via mail, email, instant message, and/or the like. For another example, the healthcare provider may submit information related to the medical bill

In one embodiment, at step 614, the physician's point of service terminal receives partial compensation from the user's insurance company for the healthcare that was provided to the user. At step 616, the physician's point of service terminal sends a balance due billing to the user's mobile device, for instance, to an email address or as a text message by use of the user's cellular telephone number.

In one embodiment, at step 618, the mobile device renders to the user a description of the bill as received for the balance due billing from the physician. The rendered bill, shown in step number 118, shows the amount due, the description of the goods and/or services of the healthcare provided to the user by the healthcare provider, and a Merchant Commodity Code (MCC) of the physician or healthcare provider. At step 620 the user's web-enabled device executes an application, which may also perform the rendering at step 618, where a decisioning process takes place in order to satisfy the bill rendered at step 618.

In one embodiment, the user may obtain and install a mobile application which determines payment accounts in order to pay the bill shown in step 618. To make the determination, the mobile application draws upon one or more online databases to which it has access. Arrow 622 shows online access to a plurality of databases 624. These databases include a database having miscellaneous data for the user, a database for insurance payment coverage rules, a database for local negative wealth impactor and government rules, and one or more databases showing various account balances that have been issued by issuers to the user that have credit or currency available to satisfy the bill shown in step 118. Various rules for incentives and penalties are contained within in the databases as seen at block 124. For instance, available balances for Medicare Part D provisions can be shown as being available to satisfy the bill in step 118.

The various databases can also include considerations for government insurance, pharmacy benefits, employer healthcare considerations, employer pharmacy benefit plans, employer or government subsidizing of healthcare goods and services, and incentives or penalties to use accounts according to negative wealth impactor code provisions as provided by various business rules. The available deductibles and required deductibles for each of the one or more benefit plans can be found in one or more databases seen at reference numeral 624, as well as various co-pay requirements, pre-negative wealth impactor healthcare spending limits, and various negative wealth impactor deferred currency amounts. Various forfeiture rules, such as are applicable to Flexible Savings Accounts (FSA) can also be found in databases 624. The relative merits of using an HSA, with its negative wealth impactor deferred deposit benefits, as well as the ability to grow its balance in terms of both compounding interest and the probability of a rise in the values of various equity holdings, are also taken into consideration. The various user account balances maintained by the databases of block 624 can be assessed via one or more issuers of the respective user accounts as seen at 634. Each issuer is an issuer to an account of the user, who is an account holder on that account that was issued by the issuer.

After the mobile application seen at process 620 receives information, business rules, and data via communication seen at arrow 622, the process 620 calculates a recommendation of one or more accounts having respective one or more amounts to be paid from each account. This recommendation will provide the most favorable tax, cost, and benefits to the user by using the amounts and respective accounts, while also minimized penalties for such use. The mobile applications recommendations are rendered on the mobile device at step 628a as shown in FIG. 6. The rendering on the web-enabled mobile device may also guard access such as by prompting for, and validating, a user name and the password to enable making withdrawals from respective accounts for respective amounts suggested by process 120. Each account can be identified by a nickname or identifier, and the nickname will be listed along with the amount that is recommended to be paid from that account toward the balance due billing shown at block 618.

For example, in one implementation, a Visa debit or credit account or a prepaid card may be suggested and identified by a nickname (i.e., a partial account number) along with an amount to be paid from that account. The user has the option to accept or reject the recommendation made as rendered on the web-enabled mobile device at step 628a. If the user decides to reject the payment recommendation, an override can be submitted by the user to change the account and/or amounts and to make effective the changes or to amend the recommendations as to the amounts to be paid from various accounts by the user to the physician. This payment is seen in step 628b where the physician's POS receives a wireless communication from the user's web-enabled mobile device. This wireless communication will contain data that reflects each account and each corresponding amount to be paid from each account to satisfy the balance due billing shown at step 618.

In one embodiment, at arrows 630 and 632, the physician communicates with its acquirer and with a transaction handler (i.e., VisaNet) to send an authorization request for each payment for each account that is designated by the wireless communication from the web-enabled mobile device to the physician's POS. The authorization request is sent from VisaNet via communication 634 to the issuer of each account from which a payment is to be made. Each issuer, respectively, sends an authorization response to the authorization request back to VisaNet, which is in turn sent from VisaNet to the physician's acquirer as shown by communication arrow 632, and from there to the physician's acquirer via communication arrow 630 back to the physician's POS. Once the physician's POS has received an authorization response for the payment from each account, then the physician may deem that the bill, as shown in block 618, has been satisfied. Thereafter, the physician's office, with its acquirer, will initiate a clearing and settlement process for each authorized payment from each account that was used to satisfy the balance due billing seen at block 618.

FIG. 6B provides a logic flow diagram illustrating alternative embodiments of the HPP-Platform. In one embodiment, the user 102 may register to the HPP-Platform 120 prior to utilizing the HPP-Platform payment service after healthcare treatment.

In one embodiment, the user 102 may submit a request 650 for registration with the HPP-Platform, e.g., via an email, a text message, a telephonic phone call to customer service, and/or the like. The HPP-Platform may then provide a HPP-Platform mobile component 653 to the user. For example, the HPP-Platform may provide an indication, a link, etc. for downloading a mobile payment application to the user's mobile device, via which the user may register one or more multi-purpose accounts with the HPP-Platform and process healthcare claims and payments in real-time.

In one embodiment, the user 102 may download and install the HPP-Platform component on a mobile device 655, e.g., an Apple iPhone, etc. The user 102 may then register with the HPP-Platform via the installed HPP-Platform component, by submitting healthcare insurance information and setting up payment accounts 658. For example, the user may associate his FSA/HSA accounts with the HPP-Platform. For another example, the user may be presented rule choices within agreement and IRS policies, and set up his rules and parameters for usage of his FSA/HAS payment accounts. For example, the user may set up a rule such that any medical purchase less than $100.00 until the end of the year will be paid by his FSA account.

For example, a user may set up accounts and spending rules for the HPP-Platform as illustrated in one example in the following table:

| | |
|---|---|
| Primary Account: | Flexible Spending Account (FSA) |
| Balance: | $500.00 |
| End Date: | 12/31/XXXX |
| Rules: | 1. Only use for medical MCC |
| | 2. Use for purchases less than $100.00 |
| | until 10/01/XXXX |
| | 3. After 10/01/XXXX, use available balance |
| | for all medical MCC purchases. |
| Second Account: | Health Savings Account (HSA) |
| Balance: | $5000.00 |
| Rules: | 1. Use for medical MCC |
| | 2. Use for purchases greater than 2000.00 |
| | 3. Use as tertiary fund for medical MCC |
| | purchases |
| Third Account: | Revolving Line of Credit (LOC) |
| Credit Line: | $5000.00 |
| Rules: | 1. Use for any MCC |
| | 2. Use for purchases greater than $100 but |
| | less than $2000.00 |
| | 3. Use as secondary account for medical |
| | purchase |

In one embodiment, the HPP-Platform may provide default settings and rules for the user via a user interface, e.g., the mobile component installed on the user's mobile device. In another embodiment, the user may configure a variety of parameters. In the above example, the user may edit the balancing amount of an account, the end date, the rules, and/or the like.

In one embodiment, upon receiving user provided registration data and related parameters and spending rules, the HPP-Platform may validate the insurance information with the insurance provider 150, and setup spending rules associated with the user's HPP-Platform account 660 to complete the registration. In another implementation, the HPP-Platform 120 may register the user's mobile device for security, such as, via a hardware ID, MAC address, and/or the like.

In one embodiment, after the user is present at a healthcare provider for medical services, the healthcare provider 110 may submit medical claim information to an insurance provider 150 at checkout, wherein the insurance provider may approve an insured portion 668 based on the user's insurance policy. In one implementation, the user may send a payment file (e.g., via text message, email, etc.) to the HPP-Platform, including the amount of patient responsibility, NPI, plan membership, SSN, etc. The HPP-Platform may then verify the submitted user data with verify against the healthcare registration record. If the record matches, the HPP-Platform may generate a “please pay an amount XXX” message and send to the user.

In one implementation, the healthcare provider 110 may send the remaining balance of the medical bill to the HPP-Platform 670 for user payment processing. In another implementation, the user 102 may received a medical bill, e.g., at a mobile device, etc., in real-time at checkout, and enter the amount 671 due into his mobile device for HPP-Platform.

In one implementation, the HPP-Platform 120 may determine a recommendation of payment plan 672 to the user based on the remaining amount in the user's registered payment accounts with HPP-Platform 672, and prompt the user to select a payment method 675. Upon receiving a confirmation of payment selection, the HPP-Platform may process payment with the healthcare accounts 678, and the healthcare provider may send confirmation of payment 680.

For example, if a user goes to a primary care physician on Jun. 8, ______, i.e., more than half a year to the end date to his FSA, and a medical bill indicates a co-pay amount of $50.00, the user may enter $50.00 into the HPP-Platform mobile application and indicate it is medical purchase. The HPP-Platform may then assess the rules in the above example, and provide a screen of options showing the remaining balances in the three accounts, e.g., FSA ($500.00), LOC ($2900), HAS ($5000.00). In one implementation, the HPP-Platform may list the available accounts in a prioritized order based on the spending rules. For example, in the above example, although LOC is the third account after the HSA, LOC is listed prior to HSA as the rule specifies LOC is applied as secondary account for medical purchase.

For another example, if the user goes to a physical therapist at Sep. 27, ______, i.e., approximately three months to the end date of FSA, and the patient's responsibility is $100.00, the user may enter $100.00 into the HPP-Platform mobile component and confirm it is medical purchase, as shown in the example screen shots in FIG. 6C. In FIG. 6C, the user may press a “pay” button 680 to enter an amount and type of purchase 685. The HPP-Platform may then respond by listing the remaining balances, e.g., FSA ($750.00), LOC ($3200), and HSA ($5000.00), as shown at 690 in FIG. 4C. In this case, even if the FSA has insufficient funds, it is on top of the prioritized list because it will expire at the end of the year. As the remaining balance in FSA is insufficient to cover the amount due, the user may split the amount by selecting FSA to pay $75.00 and LOC to pay the remaining $100-$75=$25. The HPP-Platform may send a report summary to the user including the updated remaining balance of the accounts after payment, and/or the like, as illustrated at 693 in FIG. 6C.

For another example, if the user received a surgery on Sep. 30, ______, i.e., approximately three months to the end date of FSA, and received a medical bill of $2000.00: the HPP-Platform may provide a list of accounts available, e.g., LOC ($3000.00), FSA (0), HAS ($5000.00). In this case, the user may elect to select HAS for the payment.

As shown in FIG. 6C, a physician may have a point of service terminal that sends balance due billing to the patient's web-enabled mobile device 682, and access to information and data interactively between various online databases and the mobile application executing on a patient's web-enabled mobile device 684. Block 686 shows access to retrieve various negative wealth impactor rules and benefits that can be input and considered to make a recommendation as to a payment which should be made from one or more accounts. Likely income negative wealth impactor brackets for the patient's negative wealth impactor year may also be taken into consideration in arriving at a recommendation.

In one embodiment, considerations are also input through various online databases to show insurance payment coverage rules 688. These business rules may include: (i) that portion of healthcare services that are covered or not covered for a healthcare service that is rendered by a physician to a patient; (ii) various specific spending rule limits and forfeiture rules, various annual and lifetime co-payment and maximum insurance payments by the person and/or by the policy, various limits for various goods and services which may or may not be reimbursable under insurance including pharmacy, vision, and dental payments to respective healthcare service providers; (iii) insurance coverage for various types of merchants that are available as benefits and restriction of benefits including big box retailers, retail pharmacy organizations, physician-owned organizations, rehabilitation organizations, various public and private hospitals, as well as various private preferred providers for respective insurance plans; and (iv) copayments that are available for each of several different insurance vehicles.

In one embodiment, the various patient account balances may be retrieved to determine availability of currency or funds to pay the balance due bill received from the healthcare provider 690. These accounts can be assessed by online communication with the respective issuers to determine account balances. By way of example, these balances can include: (i) a balance for one or more Flexible Savings Accounts (FSA), including a current balance and the date by which all funds in each FSA account must be spent; (ii) one or more health savings accounts (HSA) including a liquid asset balance, a non-liquid asset balance that can including stocks, mutual funds, certificates of deposit, etc. In that some equities must be traded for cash in order to have access to liquid assets to satisfy the healthcare provider's balance due bill, the retrieved information can include various requirements for selling stock or other securities, including commission charges, which information can be taken into consideration by the decisioning application in making the recommendation; (iii) balances for government insurance prepaid accounts, such as Medicare and Medicaid; (iv) private insurance deductibles outstanding and yet to be paid; (v) other negative wealth impactor deferred payment accounts that are available to satisfy the healthcare provider's balance due bill, such as employee benefit plans; (vi) non-negative wealth impactor favored payment accounts and likely cash flow predictions for in each one of those accounts, such as credit available in credit cards, cash available in debit card accounts, cash available on prepaid card accounts, as well as any currency that is available by converting loyalty points for each one of these accounts so that the loyalty points can be used as currency toward balance due billing payments. Also available are calculations made by the mobile application of award thresholds if a payment is made so as to thereby realize more loyalty points that can then be converted into currency to satisfy the healthcare provider's balance due billing.

The various inputs and data that are retrieved are subjected to various calculations as derived from steps 686 through 690 so that the mobile application can make a recommendation as to each account, and each amount to be paid from each account, that will be in the patient's best interest to pay a balance due billing received by the web-enabled mobile device from the patient's physician or other healthcare provider via a point of service terminal 692.

FIG. 6D shows an exploded screen shot of a display terminal within embodiments of the HPP-Platform. In one implementation, a horizontal and vertical icon is rendered on the screen so that a user can navigate to view vertical and horizontal portions of the display screen, as indicated by icons 695/696. Screen shot shows the total balance due from the physician as well as each of the accounts 1 through N, and respective amounts to be paid from accounts 1 through N, as recommended by the mobile application to satisfy the healthcare provider's balance due billing. As shown in display screen, the patient can accept the recommended payments from each recommended account by clicking in one location. Alternatively, the patient can edit the respective accounts and their respective payments from each account, by ‘clicking’ on an icon at another location. As a third option, the user can ‘click on’ an icon to receive a rendering of an explanation on display screen as to why the recommendations from each account for each amount was recommended. The explanation will give the patient an understanding upon which the patient can base an approval, modification, or rejection of the recommended payments from each account.

Once the recommendations are accepted, where the patient's web-enabled mobile device transmits to the physician's point of service terminal a communication that describes the payment to be made from each account. An e-commerce server, shown at block 697, processes each payment from each account as is described in FIG. 6A through the issuer processer, the acquirer processer, and the transaction handler (VisaNet) for a clearing and settlement process by which the physician's accounts 698 receivable satisfied as to the balance due payment made by the patient, as shown in block 626.

In one implementation, the patient may operate a web-enabled mobile computing device 699 that can be executing a World Wide Web browser, or other special purpose software, in order to access databases.

In one implementation, the HPP-Platform may allow the patient to view specifics of the balance due billing that the physician is charging the patient, as well as funds for payment of the balance due billing. The patient can provide information to the web-enabled mobile device in order to gain access to financial information stored by each issuer that issued an account to the patient. To access financial information for the patient, a name and password can be required. Once supplied by the patient, financial information can be sent and retrieved. This information can include account issuer identifiers (e.g.; account numbers), the name of the issuer who issued the account numbers, and any amounts that the financially responsible person wishes to pay on balance due billing to the doctor. Specifics of a bill that the patient can view may include: (i) the healthcare organization name that provided healthcare services to the patient, (ii) the name of the physician who treated the patient, (iii) the name of the person who is financially responsible for the patient, (iv) the name of the patient, (v) the date the services were provided by the doctor to the patient, (vi) a description of the healthcare goods and/or services that were rendered to the patient by the doctor, (vii) any amounts paid by the insurance company for the foregoing healthcare goods and services, and (viii) any balance due by the person who is financially responsible for the patient to the healthcare organization.

### HPP-Platform Mobile Wallet

FIGS. 8A-8G provide exemplary mobile wallet UIs illustrating wallet account within embodiments of the HPP-Platform. With reference to FIG. 8A, in some embodiments, a mobile device 800 of the user may present a graphical user interface (GUI) 801 (e.g., a home screen) including a GUI element 802 to start up a virtual wallet application (e.g., an Apple® iPhone/iPad app, Google Android application, Windows® Mobile application, etc.). For example, the icon 802 may indicate the wallet is enabled with HPP-Platform service and the wallet has registered a HPP-Platform prepaid account (e.g., see 402b in FIG. 4A).

With reference to FIG. 8B, in some embodiments, when a user activates the GUI element 801 of FIG. 8A, the mobile device may provide a virtual mobile wallet application interface 810. In some embodiments, the application interface may include a GUI element 811 to initiate a payment communication (e.g., transmitting a credit/debit/prepaid card number via NFC/Bluetooth/cellular communication). In some embodiments, the mobile device may utilize default values for the payment information (e.g., credit/debit/prepaid card information) and communication mode (e.g., NFC). In alternate embodiments, the user may be able to modify the payment information prior to communicating with a PoS terminal to initiate the payment transaction. For example, a GUI element 814 may provide a mechanism to modify payment information without leaving the “tap to pay” screen provided by application interface 810 (see, e.g., elements 820-221 of FIG. 8C). As another example, a GUI element 813 may, when activated by the user, present the user an application interface wherein the user may make more detailed adjustments to aspects of the payment mechanism (e.g., card utilized, anonymization/security preferences, etc.). In some embodiments, the user may be able to quickly revert to utilizing default payment settings by activating a GUI element 812. In some embodiments, the user may be able to stop a communication of payment information that is in progress by activating a GUI element 815 (“tap to stop”) that the application interface presents during the communication of payment information.

With reference to FIG. 8C, in some embodiments, the user may activate a GUI element 820 when operating the virtual mobile wallet application in a payment activation application interface to obtain a menu of card selection options 821a-c. For example, the user may add a HPP-Platform prepaid account 821a to the wallet upon obtaining a card number (e.g., see 402a in FIG. 4A). The user may activate any of the card selection options to quickly modify the payment information utilized in the communication to trigger the payment transaction. In some embodiments, the user may activate GUI element 822 to obtain an application interface 823 (“my cards”) for a more detailed view, from which the user can make selections of payment options. For example, a GUI element 824 may describe types of payment options (e.g., payment cards, loyalty cards, NFC tags, etc.) available to the user. The specific payment options may be depicted in GUI elements 825a-b. In some embodiments, the GUI elements 825a-b may be arranged as a column browser, with multiple columns (see 826). In some embodiments, the interface may provide a GUI element 827 that the user can activate to add a new payment option to the existing payment options displayed in the GUI elements 825a-b.

With reference to FIG. 8D, in some embodiments, activating a GUI element corresponding to a payment options may provide a detailed view of the payment option, e.g., 830 (“manage my card”). The view may include a graphical view 831a of the payment option, providing information including, without limitation: card payment processor (e.g., “Visa”), card number, payment mechanism (e.g., “Visa payWave”), cardholder name, expiration date, and/or the like. The view may also include indications of information such as, without limitation: a current balance 832, a maximum payment amount currently permissible using the card, a date on which a balance payment is due, and/or the like. The view may include a GUI element 833 that the user can activate to utilize the payment option in the purchase transaction initiation. In some embodiments, the view may include a GUI element 834 that the user can activate to view recent purchase transactions initiated using the payment option currently being displayed in 831a. The view may also include a GUI element 835 that the user can activate to add funds to the payment option currently being displayed in 831a. In some embodiments, the payment options may be arranged within a column browser interface, such that user can scan through the various payment options (e.g., 831b-e) by swiping a touchscreen of the mobile device (see 836a). As the user scans through the payment options, GUI element 836b-e may modify to indicate the user's position within the column browser interface.

With reference to FIG. 8E, the user may be able to view a record of recent transactions 840 initiated using a payment option (e.g., by activating GUI element 834 of FIG. 8D). In the recent transactions view 840, the user may be provided with a record listing 845, including information on a time of a purchase transaction (“when” 841), a description of the transaction (“what” 842), an amount of the transaction (“amount” 843), and a location of the transaction (“where” 844). The user may be able to scroll through a long list of recent transactions by activating a GUI element 846 (“view more”). In some embodiments, the user may activate a GUI element 847 to obtain a view of transactions placed on a geographical map, so that the user may understand better where each of the user's transactions originate.

With reference to FIG. 8F, in some embodiments, the user may be able to add funds to a payment option to the virtual mobile wallet application (e.g., by activating GUI element 835 of FIG. 8D). The application may provide an “add funds” interface 850. The interface may include a graphical depiction of the payment option to which funds may be added. The user may modify the payment option to which to add funds by activating the GUI element 851 (e.g., via an embedded column browser, so that only GUI element 851 is modified, while the other GUI elements in the interface remain static). The user may be able to specify a transfer amount 852, e.g., by activating the GUI element 852, and then typing a transfer amount into a GUI element 858 using a virtual keyboard GUI element 859. The user may specify a source of funds 853 to add funds to the payment option, e.g., by activating GUI element 853, and then selecting a funding source 860, such as the example funding sources 861-862, from a GUI element such as a dropdown box, auto-complete search form, etc. In some embodiments, the user may be required to provide a security code 854 (e.g., CVV2 number) for the source of funds before the source can be authorized to provide the funds to add to the payment option within the user's virtual mobile wallet application. The user may be able to activate GUI element 854, and then type the security code into a GUI element using a virtual keyboard GUI element 864.

In further implementations, if the user selects “HPP-Platform prepaid” as the funding source, the user may trigger the HPP-Platform insurance pre-861 authorization. For example, the user may be prompted to enter a “schedule date,” “provider name,” “procedure code” 863 so that such information may be forwarded to an insurance provider for pre-authorization of insured amount, e.g., see 103 in FIG. 1B. Alternatively, the wallet may automatically direct the user to an information submission page, similar to that illustrated in FIG. 7.

Upon insurance provider pre-approval of the scheduled procedure, the interface may provide a notification 865 of the entered settings, and request confirmation of the settings before processing funds addition to the user's payment option. The user may either cancel 866, or accept for transfer 867 the settings for which confirmation is requested. Upon obtaining confirmation, the application may process (see 868) the funds addition request, and provide a confirmation of addition of funds 869.

With reference to FIG. 8G, in some embodiments, the user may activate a GUI element 873 (“add new card”) within the payment options interface 870, to add a new payment option to the user's virtual mobile wallet application. The user may select a type 871 of payment option (e.g., credit/debit/prepaid/loyalty card, NFC tag, etc.) to add to the list of payment options 872. The application may provide an interface 874 wherein the user can enter user (e.g., cardholder) and payment information 875. The user may enter information by activating the GUI element corresponding to that information, and then typing in information into that GUI element by using an on-demand virtual keyboard GUI element 878. The user may cancel 877 addition of a new payment option at any time before the user proceeds to add the payment option 876 to the virtual mobile wallet application interface.

FIGS. 9A-9B provide exemplary mobile wallet UIs illustrating making a payment within embodiments of the HPP-Platform. With reference to FIG. 9A, in another embodiment, a user may select the bills 916 option. Upon selecting the bills 916 option, the user interface may display a list of bills and/or receipts 916a-h from one or more merchants. Next to each of the bills, additional information such as date of visit, whether items from multiple stores are present, last bill payment date, auto-payment, number of items, and/or the like may be displayed. In one example, the wallet shop bill 916a dated Jan. 20, 2015 may be selected. The wallet shop bill selection may display a user interface that provides a variety of information regarding the selected bill. For example, the user interface may display a list of items 916k purchased, <<916i>>, >, a total number of items and the corresponding value. For example, as shown at 916a, the user may elect to pay for a bill for “Knee Surgery” 916a performed at Jan. 20, 2015, which comprises details of the healthcare treatment performed for the user 916k.

A user may now select any of the items and select buy again to add purchase the items. The user may also refresh offers 916j to clear any invalid offers from last time and/or search for new offers that may be applicable for the current purchase. As shown in FIG. 9A, a user may select two items for repeat purchase. Upon addition, a message 916l may be displayed to confirm the addition of the two items, which makes the total number of items in the cart 14.

In some implementations, the HPP-Platform wallet may provide the HPP-Platform with the GPS location of the user. Based on the GPS location of the user, the HPP-Platform may determine the context of the user (e.g., whether the user is in a store, doctor's office, hospital, postal service office, etc.). Based on the context, the user app may present the appropriate fields to the user, from which the user may select fields and/or field values to send as part of the purchase order transmission. For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 9B, in one embodiment, the wallet mobile application may provide a user with a number of options for paying for a transaction via the wallet mode Error! Reference source not found.10. In one implementation, an example user interface 911 for making a payment is shown. The user interface may clearly identify the amount 912 and the currency Error! Reference source not found.13 for the transaction. The amount may be the amount payable and the currency may include real currencies such as dollars and euros, as well as virtual currencies such as reward points. The amount of the transaction 914 may also be prominently displayed on the user interface. The user may select the funds tab 916 to select one or more forms of payment 917, which may include various credit, debit, gift, rewards and/or prepaid cards. The user may also have the option of paying, wholly or in part, with reward points. For example, the graphical indicator 918 on the user interface shows the number of points available, the graphical indicator 919 shows the number of points to be used towards the amount due 234.56 and the equivalent 920 of the number of points in a selected currency (USD, for example).

In one implementation, the user may combine funds from multiple sources to pay for the transaction. The amount 919 displayed on the user interface may provide an indication of the amount of total funds covered so far by the selected forms of payment (e.g., Discover card and rewards points). The user may choose another form of payment or adjust the amount to be debited from one or more forms of payment until the amount 919 matches the amount payable 914. Once the amounts to be debited from one or more forms of payment are finalized by the user, payment authorization may begin.

In one implementation, the user may select a secure authorization of the transaction by selecting the cloak button 922 to effectively cloak or anonymize some (e.g., pre-configured) or all identifying information such that when the user selects pay button 921, the transaction authorization is conducted in a secure and anonymous manner. In another implementation, the user may select the pay button 921 which may use standard authorization techniques for transaction processing. In yet another implementation, when the user selects the social button 923, a message regarding the transaction may be communicated to one of more social networks (set up by the user) which may post or announce the purchase transaction in a social forum such as a wall post or a tweet. In one implementation, the user may select a social payment processing option 923. The indicator 924 may show the authorizing and sending social share data in progress.

In another implementation, a restricted payment mode 929 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 926 under the funds tab to select specialized accounts such as a flexible spending account (FSA) 927, health savings account (HAS), and/or the like and amounts to be debited to the selected accounts. In one implementation, such restricted payment mode 929 processing may disable social sharing of purchase information.

In one embodiment, the wallet mobile application may facilitate importing of funds via the import funds user interface 928. For example, a user who is unemployed may obtain unemployment benefit fund 929 via the wallet mobile application. In one implementation, the entity providing the funds may also configure rules for using the fund as shown by the processing indicator message 930. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

### HPP-Platform Controller

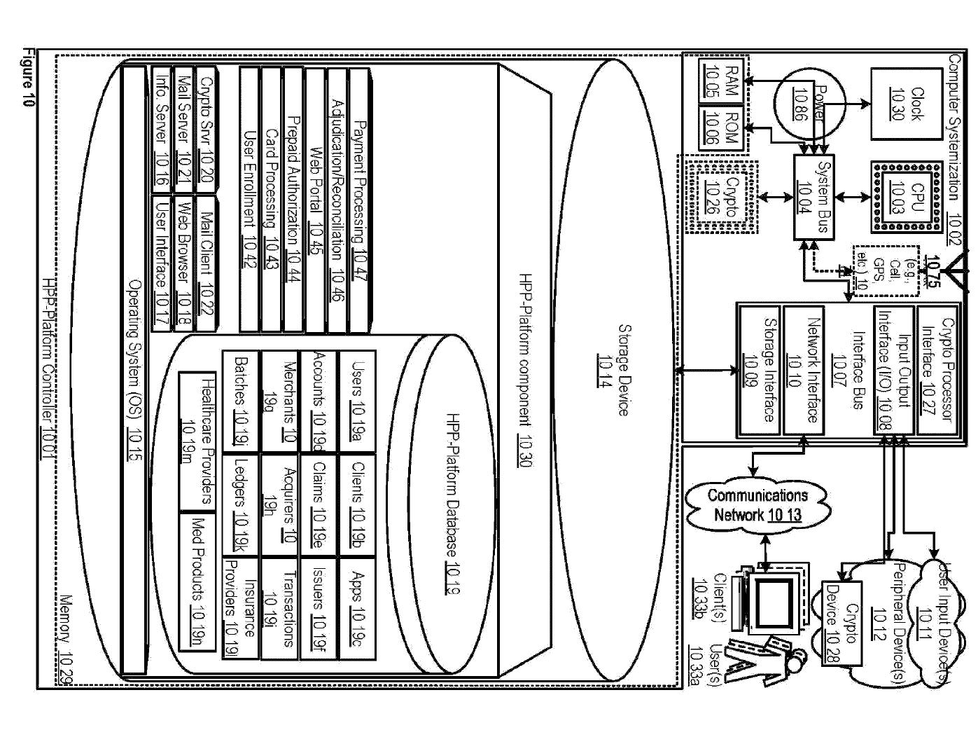

FIG. 10 shows a block diagram illustrating embodiments of a HPP-Platform controller. In this embodiment, the HPP-Platform controller 1001 may serve to aggregate, process, store, search, serve, identify, instruct, generate, match, and/or facilitate interactions with a computer through secure communication technologies, and/or other related data.

Typically, users, which may be people and/or other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the HPP-Platform controller 1001 may be connected to and/or communicate with entities such as, but not limited to: one or more users from user input devices loll; peripheral devices 1012; an optional cryptographic processor device 1028; and/or a communications network 1013.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The HPP-Platform controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and/or “processor(s)” (these terms are used interchangeable throughout the disclosure unless noted to the contrary)) 1003, a memory 1029 (e.g., a read only memory (ROM) 1006, a random access memory (RAM) 1005, etc.), and/or an interface bus 1007, and most frequently, although not necessarily, are all interconnected and/or communicating through a system bus 1004 on one or more (mother)board(s) 1002 having conductive and/or otherwise transportive circuit pathways through which instructions (e.g., binary encoded signals) may travel to effectuate communications, operations, storage, etc. The computer systemization may be connected to a power source 1086; e.g., optionally the power source may be internal. Optionally, a cryptographic processor 1026 and/or transceivers (e.g., ICs) 1074 may be connected to the system bus. In another embodiment, the cryptographic processor and/or transceivers may be connected as either internal and/or external peripheral devices 1012 via the interface bus I/O. In turn, the transceivers may be connected to antenna(s) 1075, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing HPP-Platform controller to determine its location)); Broadcom BCM4329FKUBG transceiver chip (e.g., providing 802.11n, Bluetooth 8.1+EDR, FM, etc.); a Broadcom BCM47501UB8 receiver chip (e.g., GPS); an Infineon Technologies X-Gold 618-PMB9800 (e.g., providing 8G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1029 beyond the processor itself; internal memory may include, but is not limited to: fast registers, various levels of cache memory (e.g., level 1, 8, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the HPP-Platform controller and beyond through various interfaces. Should processing requirements dictate a greater amount speed and/or capacity, distributed processors (e.g., Distributed HPP-Platform), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the HPP-Platform may be achieved by implementing a microcontroller such as CAST's R8051XC2 microcontroller; Intel's MCS 51 (i.e., 8051 microcontroller); and/or the like. Also, to implement certain features of the HPP-Platform, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the HPP-Platform component collection (distributed or otherwise) and/or features may be implemented via the microprocessor and/or via embedded components; e.g., via ASIC, coprocessor, DSP, FPGA, and/or the like. Alternately, some implementations of the HPP-Platform may be implemented with embedded components that are configured and used to achieve a variety of features or signal processing.

Depending on the particular implementation, the embedded components may include software solutions, hardware solutions, and/or some combination of both hardware/software solutions. For example, HPP-Platform features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the HPP-Platform features. A hierarchy of programmable interconnects allow logic blocks to be interconnected as needed by the HPP-Platform system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the HPP-Platform may be developed on regular FPGAs and then migrated into a fixed version that more resembles ASIC implementations. Alternate or coordinating implementations may migrate HPP-Platform controller features to a final ASIC instead of or in addition to FPGAs. Depending on the implementation all of the aforementioned embedded components and microprocessors may be considered the “CPU” and/or “processor” for the HPP-Platform.

### Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the HPP-Platform thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

### Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the HPP-Platform controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed HPP-Platform), architectures may similarly be employed to pool, load balance, and/or otherwise increase the communicative bandwidth required by the HPP-Platform controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices loll, peripheral devices 1012, cryptographic processor devices 1028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1011 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1012 may be connected and/or communicate to I/O and/or other facilities of the like such as network interfaces, storage interfaces, directly to the interface bus, system bus, the CPU, and/or the like. Peripheral devices may be external, internal and/or part of the HPP-Platform controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the HPP-Platform controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the HPP-Platform controller. A MC68HC16 microcontroller, manufactured by Motorola Inc., may be used for and/or within cryptographic units. The MC68HC16 microcontroller utilizes a 16-bit multiply-and-accumulate instruction in the MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the HPP-Platform controller and/or a computer systemization may employ various forms of memory 1029. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1029 may contain a collection of program and/or database components and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); the HPP-Platform component(s) 1035; and/or the like (i.e., collectively a component collection). These components may be stored and accessed from the storage devices and/or from storage devices accessible through an interface bus. Although non-conventional program components such as those in the component collection, typically, are stored in a local storage device 1014, they may also be loaded and/or stored in memory such as: peripheral devices, RAM, remote storage facilities through a communications network, ROM, various forms of memory, and/or the like.

### Operating System

The operating system component 1015 is an executable program component facilitating the operation of the HPP-Platform controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 8000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the HPP-Platform controller to communicate with other entities through a communications network 1013. Various communication protocols may be used by the HPP-Platform controller as a subcarrier transport mechanism for interaction, such as, but not limited to: multicast, TCP/IP, UDP, unicast, and/or the like.

### Information Server

An information server component 1016 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the HPP-Platform controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 81, and/or the like. An information server may communicate to and/or with other components in a component collection, including itself, and/or facilities of the like. Most frequently, the information server communicates with the HPP-Platform database 1019, operating systems, other program components, user interfaces, Web browsers, and/or the like.

Access to the HPP-Platform database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the HPP-Platform. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the HPP-Platform as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 8000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the HPP-Platform enabled nodes. The combined application may be nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the HPP-Platform.

Access to the HPP-Platform mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POPS, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the HPP-Platform may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the HPP-Platform component to engage in secure transactions if so desired. The cryptographic component facilitates the secure accessing of resources on the HPP-Platform and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The HPP-Platform Database

The HPP-Platform database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the HPP-Platform database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the HPP-Platform database is implemented as a data-structure, the use of the HPP-Platform database 1019 may be integrated into another component such as the HPP-Platform component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 1019a-n. A Users table 1019a may include fields such as, but not limited to: user_id, applicant_id, firstname, lastname, address_line1, address_line2, dob, ssn, credit_check_flag, zipcode, city, state, account_params_list, account_mode, account_type, account_expiry, preferred_bank_name, preferred_branch_name, credit_report, and/or the like. The User table may support and/or track multiple entity accounts on a HPP-Platform. A Clients table 1019b may include fields such as, but not limited to: client_ID, client_type, client_MAC, client_IP, presentation_format, pixel_count, resolution, screen_size, audio_fidelity, hardware_settings_list, software_compatibilities_list, installed_apps_list, and/or the like. An Apps table 1019c may include fields such as, but not limited to: app_ID, app_name, app_type, OS_compatibilities_list, version, timestamp, developer_ID, and/or the like. An Accounts table 1019d may include fields such as, but not limited to: user_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Claims table 1019e may include fields such as, but not limited to: user_id, claim_id, timestamp claim_type, snapshot_array, receipt_data, process_sent_flag, process_clear_flag, and/or the like. An Issuers table 1019f may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, issuer_id, issuer_name, issuer_address, ip_address, mac_address, auth_key, port_num, security_settings_list, and/or the like. A Merchants table 1019g may include fields such as, but not limited to: merchant_id, merchant_name, provi merchant_address, ip_address, mac_address, auth_key, port_num, security_settings_list, and/or the like. An Acquirers table 1019h may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Transactions table 1019i may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 1019j may include fields such as, but not limited to: applicant_firstname, applicant_lastname, applicant_address_line1, applicant_address_line2, consumer_bureau_data_list, consumer_bureau_data, applicant_clear_flag, credit_limit, credit_score, account_balances, delinquency_flag, quality_flags, batch_id, transaction_id_list, timestamp_list, cleared_flag_list, clearance_trigger_settings, and/or the like. A Ledgers table 1019k may include fields such as, but not limited to: request_id, timestamp, deposit_amount, batch_id, transaction_id, clear_flag, deposit_account, transaction_summary, payor_name, payor_account, and/or the like. An Insurance Provider table 1019l may include fields such as, but not limited to InsuranceID, InsuranceName, InsuranceProgram, InsuranceBIN, InsuranceCoverageTable, InsuranceVeriCode, InsuranceAuthorization, and/or the like. A Healthcare Provider table 1019m may include fields such as, but not limited to HealthProviderID, HealthProviderName, HealthProviderZipcode, HealthProviderProcedureCode, HealthProviderClaimCode, HealthProviderPricingList, and/or the like. A medical products/services table 1019n may include fields such as, but not limited to authorizedMedProductID, authorizedMedServiceID, ProductCode, ServiceProcedureCode, HealthProviderID, InsuranceID, InsuranceCoverageRate, PricingRate, and/or the like.

In one embodiment, the HPP-Platform database may interact with other database systems. For example, employing a distributed database system, queries and data access by search HPP-Platform component may treat the combination of the HPP-Platform database, an integrated data security layer database as a single database entity.

In one embodiment, user programs may contain various user interface primitives, which may serve to update the HPP-Platform. Also, various accounts may require custom database tables depending upon the environments and the types of clients the HPP-Platform may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-n. The HPP-Platform may be configured to keep track of various settings, inputs, and parameters via database controllers.

The HPP-Platform database may communicate to and/or with other components in a component collection, including itself, and/or facilities of the like. Most frequently, the HPP-Platform database communicates with the HPP-Platform component, other program components, and/or the like. The database may contain, retain, and provide information regarding other nodes and data.

### The HPP-Platforms

The HPP-Platform component 1035 is a stored program component that is executed by a CPU. In one embodiment, the HPP-Platform component incorporates any and/or all combinations of the aspects of the HPP-Platform that was discussed in the previous figures. As such, the HPP-Platform affects accessing, obtaining and the provision of information, services, transactions, and/or the like across various communications networks.

The HPP-Platform transforms patient insurance information, and healthcare procedure schedule information inputs via HPP-Platform components such as user enrollment 1042, card processing 1043, prepaid authorization 1044, web portal 1045, adjudication/reconciliation 1046, payment processing 1047, and/or the like into medical claim settlement outputs.

The HPP-Platform component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the HPP-Platform server employs a cryptographic server to encrypt and decrypt communications. The HPP-Platform component may communicate to and/or with other components in a component collection, including itself, and/or facilities of the like. Most frequently, the HPP-Platform component communicates with the HPP-Platform database, operating systems, other program components, and/or the like. The HPP-Platform may contain, communicate, generate, obtain, and/or provide program component, system, user, and/or data communications, requests, and/or responses.

### Distributed HPP-Platforms

The structure and/or operation of any of the HPP-Platform node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the HPP-Platform controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the HPP-Platform controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header (‘Content-Type: text/plain’);
// set ip address and port to listen to for incoming data
$address = ‘192.168.0.100’;
$port = 855;
// create a server-side SSL socket, listen for/accept incoming
communication
$sock = socket_create(AF_INET, SOCK_STREAM, 0);
socket_bind($sock, $address, $port) or die(‘Could not bind to
address’);
socket_listen($sock);
$client = socket_accept($sock);
// read input data from client device in 1024 byte blocks until end
of message
do {
    $input = “”;
    $input = socket_read ($client, 1024);
    $data .= $input;
} while ($input != “”);
// parse data to extract variables
$obj = json_decode($data, true);
// store input data in a database
mysql_connect (“201.408.185.132”, $DBserver, $password);
// access database server
mysql_select (“CLIENT_DB.SQL”); // select database to append
mysql_query (“INSERT INTO UserTable (transmission)
VALUES ($data )”); // add data to UserTable table in a CLIENT
database
mysql_close (“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

In order to address various issues and advance the art, the entirety of this application for HEALTHCARE PREPAID PAYMENT PLATFORM APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a HPP-Platform individual and/or enterprise user, database configuration and/or relational model, data type, data transmission and/or network framework, syntax structure, and/or the like, various embodiments of the HPP-Platform, may be implemented that enable a great deal of flexibility and customization. For example, aspects of the HPP-Platform may be adapted for gas/electricity corporate account payment. While various embodiments and discussions of the HPP-Platform have been directed to healthcare claim, however, it is to be understood that the embodiments described herein may be readily configured and/or customized for a wide variety of other applications and/or implementations.

What is claimed is:

1. A healthcare pre-authorizing payment processor-implemented method, comprising:
obtaining a healthcare insurance pre-authorization request including healthcare procedure schedule information and user insurance information;
receiving an indication of insurance approval of an insured amount from an insurance provider;
loading an insurance approved amount into a prepaid account of the user prior to the healthcare procedure;
receiving a payment request using the loaded prepaid account towards a medical bill after the healthcare procedure is performed;
transferring the loaded insurance approved amount in the prepaid account to a healthcare provider in response to the payment request; and
generating a transaction record including the pre-approved amount and the transferred amount.

2. The method of claim 1, wherein the healthcare insurance pre-authorization request is sent to an insurance provider.

3. The method of claim 1, wherein the healthcare insurance pre-authorization request is generated by a user via any of phone calls, text messages, emails and instant messages.

4. The method of claim 1, wherein the healthcare insurance pre-authorization request is received at a processing server and forwarded to the insurance provider by the processing server.

5. The method of claim 1, wherein the healthcare procedure schedule information comprises any of a healthcare provider ID, healthcare provider name, healthcare procedure date, healthcare procedure code, healthcare procedure description and procedure pricing estimate.

6. The method of claim 1, wherein the user insurance information comprises any of an insurance provider name, insurance group ID, and insurance policy ID.

7. The method of claim 1, wherein the insurance approval of an insured amount is made upon insurance provider verifying a healthcare cost estimate and user's insurance policy.

8. The method of claim 1, wherein the loading an insurance approved amount into a prepaid account comprises provisionally transferring the insurance approved amount from the insurance provider to the prepaid account.

9. The method of claim 1, wherein the payment request is received from a POS terminal of the healthcare provider.

10. The method of claim 1, wherein the payment request is denied by the healthcare provider if the healthcare provider is not a participating provider.

11. The method of claim 1, wherein the medical bill comprises a healthcare provider estimated insured amount.

12. The method of claim 11, further comprising:
determining whether there is sufficient prepaid funds in the prepaid account against the healthcare provider estimated insured amount.

13. The method of claim 12, further comprising:
deducting the available amount from the prepaid account when there is not sufficient prepaid funds.

14. The method of claim 1, wherein the transferring the loaded insurance approved amount in the prepaid account is completed upon insurance provider verification.

15. The method of claim 1, wherein the transferring the loaded insurance approved amount in the prepaid account is completed without insurance provider intervention after the pre-approval before the healthcare procedure is done.

16. The method of claim 1, further comprising:
retrieving the transaction record; and
comparing the pre-approved amount against the transferred amount.

17. The method of claim 16, further comprising:
reconciling the pre-approved amount with the transferred amount.

18. The method of claim 1, further comprising:
retrieve a pre-authorization record related to the healthcare procedure information;
verifying the healthcare procedure information is consistent with the transaction record.

19. The method of claim 18, further comprising:
sending the transaction record for further inspection when the healthcare procedure information is inconsistent with the transaction record.

20. The method of claim 16, further comprising:
receiving an insurance adjustment request based on the comparison.

21. A healthcare pre-authorizing payment processor-implemented method, comprising:
a memory;
a processor disposed in communication with said memory, and configured to issue a plurality of processing instructions stored in the memory, wherein the processor issues instructions to:
obtain a healthcare insurance pre-authorization request including healthcare procedure schedule information and user insurance information;
receive an indication of insurance approval of an insured amount from an insurance provider;
load an insurance approved amount into a prepaid account of the user prior to the healthcare procedure;
receive a payment request using the loaded prepaid account towards a medical bill after the healthcare procedure is performed;
transfer the loaded insurance approved amount in the prepaid account to a healthcare provider in response to the payment request; and
generate a transaction record including the pre-approved amount and the transferred amount.

22. The system of claim 21, wherein the healthcare insurance pre-authorization request is sent to an insurance provider.

23. The system of claim 21, wherein the healthcare insurance pre-authorization request is generated by a user via any of phone calls, text messages, emails and instant messages.

24. The system of claim 21, wherein the healthcare insurance pre-authorization request is received at a processing server and forwarded to the insurance provider by the processing server.

25. The system of claim 21, wherein the healthcare procedure schedule information comprises any of a healthcare provider ID, healthcare provider name, healthcare procedure date, healthcare procedure code, healthcare procedure description and procedure pricing estimate.

26. The system of claim 21, wherein the user insurance information comprises any of an insurance provider name, insurance group ID, and insurance policy ID.

27. The system of claim 21, wherein the insurance approval of an insured amount is made upon insurance provider verifying a healthcare cost estimate and user's insurance policy.

28. The system of claim 21, wherein the loading an insurance approved amount into a prepaid account comprises provisionally transferring the insurance approved amount from the insurance provider to the prepaid account.

29. The system of claim 21, wherein the payment request is received from a POS terminal of the healthcare provider.

30. The system of claim 21, wherein the payment request is denied by the healthcare provider if the healthcare provider is not a participating provider.

31. The system of claim 21, wherein the medical bill comprises a healthcare provider estimated insured amount.

32. The system of claim 31, wherein the processor further issues instructions to:
determine whether there is sufficient prepaid funds in the prepaid account against the healthcare provider estimated insured amount.

33. The system of claim 32, wherein the processor further issues instructions to:
deduct the available amount from the prepaid account when there is not sufficient prepaid funds.

34. The system of claim 21, wherein the transferring the loaded insurance approved amount in the prepaid account is completed upon insurance provider verification.

35. The system of claim 21, wherein the transferring the loaded insurance approved amount in the prepaid account is completed without insurance provider intervention after the pre-approval before the healthcare procedure is done.

36. The system of claim 21, wherein the processor further issues instructions to:
retrieve the transaction record; and
compare the pre-approved amount against the transferred amount.

37. The system of claim 36, wherein the processor further issues instructions to:
reconcile the pre-approved amount with the transferred amount.

38. The system of claim 21, wherein the processor further issues instructions to:
retrieve a pre-authorization record related to the healthcare procedure information;
verify the healthcare procedure information is consistent with the transaction record.

39. The system of claim 38, wherein the processor further issues instructions to:
send the transaction record for further inspection when the healthcare procedure information is inconsistent with the transaction record.

40. The system of claim 36, wherein the processor further issues instructions to:
receive an insurance adjustment request based on the comparison.

41. A healthcare pre-authorizing payment processor-readable storage medium storing processor-executable instructions to:
obtain a healthcare insurance pre-authorization request including healthcare procedure schedule information and user insurance information;
receive an indication of insurance approval of an insured amount from an insurance provider;
load an insurance approved amount into a prepaid account of the user prior to the healthcare procedure;
receive a payment request using the loaded prepaid account towards a medical bill after the healthcare procedure is performed;
transfer the loaded insurance approved amount in the prepaid account to a healthcare provider in response to the payment request; and
generate a transaction record including the pre-approved amount and the transferred amount.

42. The medium of claim 41, wherein the healthcare insurance pre-authorization request is sent to an insurance provider.

43. The medium of claim 41, wherein the healthcare insurance pre-authorization request is generated by a user via any of phone calls, text messages, emails and instant messages.

44. The medium of claim 41, wherein the healthcare insurance pre-authorization request is received at a processing server and forwarded to the insurance provider by the processing server.

45. The medium of claim 41, wherein the healthcare procedure schedule information comprises any of a healthcare provider ID, healthcare provider name, healthcare procedure date, healthcare procedure code, healthcare procedure description and procedure pricing estimate.

46. The medium of claim 41, wherein the user insurance information comprises any of an insurance provider name, insurance group ID, and insurance policy ID.

47. The medium of claim 41, wherein the insurance approval of an insured amount is made upon insurance provider verifying a healthcare cost estimate and user's insurance policy.

48. The medium of claim 41, wherein the loading an insurance approved amount into a prepaid account comprises provisionally transferring the insurance approved amount from the insurance provider to the prepaid account.

49. The medium of claim 41, wherein the payment request is received from a POS terminal of the healthcare provider.

50. The medium of claim 41, wherein the payment request is denied by the healthcare provider if the healthcare provider is not a participating provider.

51. The medium of claim 41, wherein the medical bill comprises a healthcare provider estimated insured amount.

52. The medium of claim 51, wherein the medium further storing processor-executable instructions to:
determine whether there is sufficient prepaid funds in the prepaid account against the healthcare provider estimated insured amount.

53. The medium of claim 52, wherein the medium further storing processor-executable instructions to:
deduct the available amount from the prepaid account when there is not sufficient prepaid funds.

54. The medium of claim 41, wherein the transferring the loaded insurance approved amount in the prepaid account is completed upon insurance provider verification.

55. The medium of claim 41, wherein the transferring the loaded insurance approved amount in the prepaid account is completed without insurance provider intervention after the pre-approval before the healthcare procedure is done.

56. The medium of claim 41, wherein the medium further storing processor-executable instructions to:
retrieve the transaction record; and
compare the pre-approved amount against the transferred amount.

57. The medium of claim 56, wherein the medium further storing processor-executable instructions to:
reconcile the pre-approved amount with the transferred amount.

58. The medium of claim 41, wherein the medium further storing processor-executable instructions to:
retrieve a pre-authorization record related to the healthcare procedure information;
verify the healthcare procedure information is consistent with the transaction record.

59. The medium of claim 58, wherein the medium further storing processor-executable instructions to:
send the transaction record for further inspection when the healthcare procedure information is inconsistent with the transaction record.

60. The medium of claim 56, wherein the medium further storing processor-executable instructions to:
receive an insurance adjustment request based on the comparison.

61. A low-latency healthcare payment processor-implemented method, comprising:
obtaining an account identifier range from an issuer in a low-latency network traffic reducing single message;
obtaining a healthcare insurance pre-authorization request including healthcare procedure schedule information and user insurance information;
assigning an account identifier from the obtained account identifier range to a source of the pre-authorization request;
loading an insurance approved amount into a prepaid account associated with the assigned account identifier prior to the healthcare procedure;
receiving a payment request using the loaded prepaid account towards a medical bill after the healthcare procedure is performed;
processing a healthcare payment transaction based on the received payment request to reduce insurance claim delays; and
generating a transaction record showing a healthcare payment of the insurance approved amount to the healthcare provider completed with decreased network and transaction latency.

62. The method of claim 61, wherein the healthcare payment of the insurance approved amount to the healthcare provider is completed within same day of the healthcare procedure.

63. The method of claim 61, wherein the account identifier range includes a plurality of card numbers associated with a plurality of physical magnetic cards.

64. The method of claim 61, wherein the account identifier range includes a plurality of virtual card numbers associated with electronic wallet entries.
